(19) United States
(12) Patent Application Publication
(10) Pub. No.: US 2025/0326348 A1
(43) Pub. Date: Oct. 23, 2025

(54) TENSIONING DEVICES FOR CONTROLLING WEBBING

(71) Applicant: TAIZHOU RUNJIE LOGISTICS SAFETY EQUIPMENT SCIENCE AND TECHNOLOGY CO., LTD., Taizhou (CN)

(72) Inventors: Jing ZHOU, Taizhou (CN); Chunzhi LI, Taizhou (CN); Xianwei YANG, Taizhou (CN); Fengquan MA, Taizhou (CN)

(73) Assignee: TAIZHOU RUNJIE LOGISTICS SAFETY EQUIPMENT SCIENCE AND TECHNOLOGY CO., LTD., Taizhou (CN)

(21) Appl. No.: 19/258,876

(22) Filed: Jul. 2, 2025

Related U.S. Application Data
(63) Continuation of application No. PCT/CN2024/087416, filed on Apr. 12, 2024.

(30) Foreign Application Priority Data
Apr. 10, 2024 (CN) 202420730672.7

(51) Int. Cl. B60P 7/08

(52) U.S. Cl. CPC B60P 7/083

(57) ABSTRACT

A tensioning device for controlling a webbing is provided, including a handle assembly, a base assembly, and a long webbing. The handle assembly includes a handle and ratchet wheels, the base assembly includes a base, the handle and the base are pivotally connected with each other through a reeling shaft, the ratchet wheels are fixedly mounted on the reeling shaft, a reel is fixed between the ratchet wheels, the ratchet wheels, the reel, and the reeling shaft rotate synchronously, the reel is sleeved outside the reeling shaft and disposed coaxially, one side of the reel is provided with an opening for the long webbing to pass through, one end of the long webbing is sleeved on the reeling shaft, and the other end of the long webbing is led out from one end of the base, one end of the reeling shaft is connected to a coiling spring assembly.

### CROSS-REFERENCE TO RELATED APPLICATIONS

This application is a continuation of International Patent Application No. PCT/CN2024/087416, filed on Apr. 12, 2024, which claims priority to Chinese Patent Application No. 202420730672.7 filed on Apr. 10, 2024, the entire contents of each of which are incorporated herein by reference.

### TECHNICAL FIELD

The present disclosure relates to the technical field of tighteners, and specifically relates to a tensioning device for controlling a webbing.

### BACKGROUND

Tighteners are securing devices used during cargo transportation, relocation, loading, or warehousing, featuring a reliable locking mechanism that prevents accidental release while offering safe, lightweight, and user-friendly operation to protect goods from damage. A standard tensioner typically consists of a handle assembly, a base assembly, ratchet wheels, and long/short webbings. During cargo securing, the long/short webbings are fixed to designated positions or interconnected, then the handle assembly is pulled reciprocally to engage the ratchet wheels via a movable pawl, which rotates the coiling spring shaft to wind the webbing until maximum tension is achieved. To release cargo, the handle is rotated to a specific angle to disengage both the movable pawl and the ratchet wheels, and the stopping pawl on the base assembly is pushed up by the handle side plate of the handle assembly and engaged from the ratchet wheels, at which time it is possible to pull out the long webbing to achieve the purpose of unlocking the goods. Some tensioners have the function of automatic rewinding of the long webbing. For such power-driven tensioning devices, when automatically retracting the long webbing, it is necessary to carefully control the retraction speed to prevent the long webbing from swinging and potentially injuring the operator. Therefore, an appropriate braking mechanism must be provided.

In view of the foregoing, it is desired to provide a tensioning device for controlling a webbing, which can be manually controlled for safe rewinding of webbing, and can also automatically rewind a long webbing, and at the same time, control the speed of rewinding of the long webbing.

### SUMMARY

One or more embodiments of the present disclosure provide a tensioning device for controlling a webbing, comprising a handle assembly, a base assembly, and a long webbing, wherein the handle assembly includes a handle and ratchet wheels, the base assembly includes a base, the handle and the base are pivotally connected with each other through a reeling shaft, the ratchet wheels are fixedly mounted on the reeling shaft, a reel is fixed between the ratchet wheels, the ratchet wheels, the reel, and the reeling shaft rotate synchronously, the reel is sleeved outside the reeling shaft and disposed coaxially, one side of the reel is provided with an opening for the long webbing to pass through, one end of the long webbing is sleeved on the reeling shaft, and the other end of the long webbing is led out from one end of the base through the opening on the reel, one end of the reeling shaft is connected to a coiling spring assembly, the coiling spring assembly includes a coiling spring and a coiling spring cartridge sleeved on the coiling spring, the base includes a base side plate and a base bottom plate, and an upper side curved surface of the base side plate is divided into a release zone and a tensioning working zone in turn. The coiling spring assembly further includes a coiling cartridge cover, the coiling cartridge cover is disposed on the coiling spring cartridge, and a brake assembly is disposed in the coiling spring cartridge.

In some embodiments, one end of the reeling shaft is provided with a C-shaped opening, and the brake assembly includes a limit tooth and a pendulum tooth, the limit tooth is connected to the coiling spring cartridge, a plurality of first internal teeth are disposed on a ring-shaped inner wall of the limit tooth that is close to the reeling shaft, a hole is in a center of the pendulum tooth, a linkage groove and a brake groove are disposed in the hole, a diagonal over-section is disposed between the linkage groove and the brake groove, the pendulum tooth is eccentrically sleeved on the C-shaped opening at the end of the reeling shaft, a first outer contour tooth is disposed on an outer side of the pendulum tooth away from the brake groove, and the pendulum tooth rotates synchronously with the reeling shaft.

In some embodiments, the upper side curved surface of the base side plate is provided with a first protrusion, the first protrusion dividing the upper side curved surface of the base side plate into the release zone and the tensioning working zone.

In some embodiments, the base side plate and the base bottom plate are of one-piece construction, the base side plate being perpendicular to the base bottom plate and symmetrically disposed on both sides of the base bottom plate.

In some embodiments, a first pawl sliding groove is disposed at a rear side of the base side plate, a first limiting plate is disposed at a rear side of the base bottom plate, the first pawl sliding groove is provided with a first pawl, the first pawl is T-shaped, both ends of the first pawl are slidably disposed at the first pawl sliding groove, a first reset spring is sleeved on a lower end of the first pawl, which is inserted into the first limiting plate and slidably matched with the first limiting plate; and the first pawl elastically slides in a direction of the first pawl sliding groove under an action of the first reset spring, and the first pawl is correspondingly cooperated with the ratchet wheels.

In some embodiments, the handle includes a handgrip and handle side plates, the handle side plates are connected to the handgrip and symmetrically disposed on both sides of the handgrip, the handle side plates are coaxially rotationally connected to the base side plate through a sleeve, the sleeve is connected with the reeling shaft so that the handle side plates are freely rotatable with the reeling shaft as a central axis, the handle side plates are provided with symmetrical second pawl slide grooves, the second pawl slide grooves are provided with a second pawl, the second pawl is L-shaped, a plastic sleeve is disposed at an upper end of the second pawl, and two ends of the second pawl are slidably disposed at the second pawl slide grooves, the second pawl is connected to one side of one of the handle side plates by a torsion spring; and the second pawl elastically slides in a direction of each of the second pawl slide grooves under an action of the torsion spring, and the second pawl is correspondingly cooperated with the ratchet wheels.

In some embodiments, the two ends of the second pawl extend out of the second pawl slide grooves and fit in the upper side curved surface of the base side plate under the action of the torsion spring.

In some embodiments, a first squeezing surface and a second squeezing surface for squeezing a first pawl are disposed on a lower side curved surface of the handle side plate.

In some embodiments, the upper side curved surface of the base side plate is further divided into an unloading section, a tightening section, and a releasing section in turn, a first locking port being disposed between the unloading section and the tightening section, and a second locking port being disposed at an end of the releasing section.

In some embodiments, a front cover is disposed on one end of the base close to the long webbing, the front cover is provided with a webbing channel for the long webbing to pass through and provided with symmetrical limit walls, and a bottom of the base is provided with symmetrical limit ports that are strip-shaped, the limit walls and the limit ports cooperating for limiting the handle and avoiding interference between sides of the handle and the ratchet wheels.

In some embodiments, the long webbing is connected with a hook, the front cover is disposed at one end of the base, the webbing channel on the front cover extends toward the other end of the base, and the webbing channel is in a constricted shape and is configured to catch one end of the hook.

In some embodiments, a safety mechanism is disposed at an opening of the hook, the safety mechanism includes a return-action spring and a safety sleeve, the return-action spring is mounted on the hook, the safety sleeve is disposed on the return-action spring and elastically closes the opening of the hook under an action of the return-action spring.

In some embodiments, a detachable connecting shaft is disposed on an end of the base opposite to the long webbing, and the detachable connecting shaft is connected with at least one of a short webbing, a hooklet, a snap, or a fixed plate.

In some embodiments, a first eccentric shaft is disposed at one end of the reeling shaft, and the brake assembly includes a locking pawl, a spring, and a fixing member, the fixing member is connected to the reeling shaft, the fixing member rotates synchronously with the reeling shaft, a second outer contour tooth is disposed on an outer periphery of the locking pawl close to the coiling spring cartridge, the locking pawl is connected to the first eccentric shaft at the end of the reeling shaft, the spring is disposed between the locking pawl and the fixing member, one end of the spring is connected to the fixing member, and the other end of the spring is connected to the locking pawl to provide a force for the locking pawl to close toward the reeling shaft; and a plurality of second internal teeth, which are consecutive and circumferentially arranged, are disposed on a ring-shaped inner wall of the coiling spring cartridge facing the locking pawl.

In some embodiments, an end of the reeling shaft is provided with a concentric screw hole, and the brake assembly includes a brake pawl, a return spring, a limiting disk, and a screw, the limiting disk is fixed at the end of the reeling shaft by matching the screw with the concentric screw hole, the limiting disk rotates synchronously with the reeling shaft, a third outer contour tooth is disposed on an outer periphery of the brake pawl close to the coiling spring cartridge, the brake pawl is connected to the limiting disk, the return spring is disposed between the brake pawl and the limiting disk, one end of the return spring is connected to the limiting disk, and the other end of the return spring is connected to the brake pawl to provide a force for the brake pawl to close toward the reeling shaft; and a plurality of third internal teeth, which are consecutive and circumferentially arranged, are disposed on a ring-shaped inner wall of the coiling spring cartridge facing the brake pawl.

In some embodiments, a second eccentric shaft is disposed on one end of the reeling shaft, and the brake assembly includes a brake disk and a compression spring, the brake disk is provided with a recess, an outer contour flange is disposed on an outer periphery of the brake disk that is close to the coiling spring cartridge, the brake disk is connected to the second eccentric shaft of the reeling shaft, the compression spring is mounted in the recess, one end of the compression spring abuts against the brake disk, the other end of the compression spring abuts against the second eccentric shaft of the reeling shaft, and the brake disk rotates synchronously with the reeling shaft.

### BRIEF DESCRIPTION OF THE DRAWINGS

FIG. 1 is an exploded schematic diagram of an exemplary tensioning device according to some embodiments of the present disclosure;

FIG. 2 is a schematic diagram of an exemplary combined state of a tensioning device according to some embodiments of the present disclosure;

FIG. 3 is a schematic diagram of an exemplary first type of base structure according to some embodiments of the present disclosure;

FIG. 4 is a schematic diagram of an exemplary second type of base structure according to some embodiments of the present disclosure;

FIG. 5 is a schematic diagram of a structure of an exemplary handle assembly according to some embodiments of the present disclosure;

FIG. 6 is a schematic diagram of a working principle of an exemplary locking position in a release zone of a first type of base structure according to some embodiments of the present disclosure;

FIG. 7 is a detailed enlargement schematic diagram of part A in FIG. 6;

FIG. 8 is a schematic diagram of a working principle of an exemplary release zone of a first type of base structure according to some embodiments of the present disclosure;

FIG. 9A is a schematic diagram of a first top view of an exemplary tensioning device according to some embodiments of the present disclosure;

FIG. 9B is a schematic diagram of a first cross-section of an exemplary tensioning device according to some embodiments of the present disclosure;

FIG. 10A is a schematic diagram of a second top view of an exemplary tensioning device according to some embodiments of the present disclosure;

FIG. 10B is a schematic diagram of a second cross-section of an exemplary tensioning device according to some embodiments of the present disclosure;

FIG. 11 is a schematic diagram of a structure of an exemplary front cover according to some embodiments of the present disclosure;

FIG. 12 is a schematic diagram of a structure of an exemplary reeling shaft according to some embodiments of the present disclosure;

FIG. 13 is an internal schematic diagram of an exemplary brake assembly (in an unwinding state) according to some embodiments of the present disclosure;

FIG. 14 is an internal schematic diagram of an exemplary brake assembly (in a locked state) according to some embodiments of the present disclosure;

FIG. 15 is an internal schematic diagram of an exemplary brake assembly (in a winding state) according to some embodiments of the present disclosure;

FIG. 16 is a schematic diagram of a structure of an exemplary first type of base structure according to some other embodiments of the present disclosure;

FIG. 17 is an exploded schematic diagram of an exemplary tensioning device according to some other embodiments of the present disclosure;

FIG. 18 is an exploded schematic diagram of an exemplary tensioning device according to some other embodiments of the present disclosure;

FIG. 19 is a schematic diagram of a structure of an exemplary reeling shaft according to some other embodiments of the present disclosure;

FIG. 20 is a schematic diagram of a structure of an exemplary brake assembly according to some other embodiments of the present disclosure;

FIG. 21 is an internal schematic diagram of an exemplary brake assembly (in an unwinding state) according to some other embodiments of the present disclosure;

FIG. 22 is an internal schematic diagram of an exemplary brake assembly (in a locked state) according to some other embodiments of the present disclosure;

FIG. 23 is an internal schematic diagram of an exemplary brake assembly (in a winding state) according to some other embodiments of the present disclosure;

FIG. 24 is an exploded schematic diagram of an exemplary tensioning device according to some other embodiments of the present disclosure;

FIG. 25 is a schematic diagram of a structure of an exemplary reeling shaft according to some other embodiments of the present disclosure;

FIG. 26 is a schematic diagram of a structure of an exemplary brake assembly according to some other embodiments of the present disclosure;

FIG. 27 is an internal schematic diagram of an exemplary brake assembly (in an unwinding state) according to some other embodiments of the present disclosure;

FIG. 28 is an internal schematic diagram of an exemplary brake assembly (in a locked state) according to some other embodiments of the present disclosure;

FIG. 29A is an internal schematic diagram of an exemplary brake assembly (in a first winding state) according to some other embodiments of the present disclosure;

FIG. 29B is an internal schematic diagram of an exemplary brake assembly (in a second winding state) according to some other embodiments of the present disclosure;

FIG. 30 is an exploded schematic diagram of an exemplary tensioning device according to some other embodiments of the present disclosure;

FIG. 31 is a schematic diagram of a structure of an exemplary reeling shaft according to some other embodiments of the present disclosure;

FIG. 32 is a schematic diagram of a structure of an exemplary brake assembly according to some other embodiments of the present disclosure;

FIG. 33 is a schematic diagram of a structure of an exemplary brake assembly according to some other embodiments of the present disclosure;

FIG. 34 is an internal schematic diagram of an exemplary brake assembly (in an unwinding state) according to some other embodiments of the present disclosure;

FIG. 35 is an internal schematic diagram of an exemplary brake assembly (in a locked state) according to some other embodiments of the present disclosure; and

FIG. 36 is an internal schematic diagram of an exemplary brake assembly (in a winding state) according to some other embodiments of the present disclosure.

### DETAILED DESCRIPTION

In order to make the purpose and the advantages of the present disclosure clearer and more understandable, the present disclosure is hereinafter specifically described in conjunction with embodiments. It should be understood that the following text is only for describing one or more specific embodiments of the present disclosure, and is not intended to strictly limit the scope of protection of the specific claims of the present disclosure.

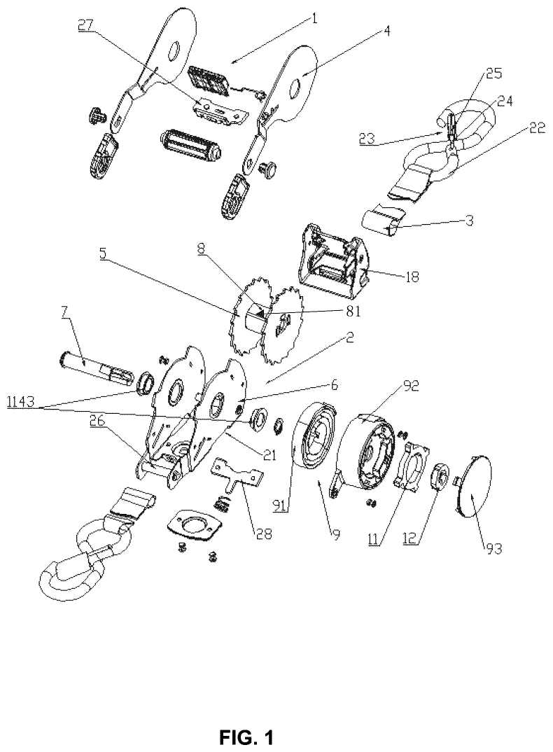

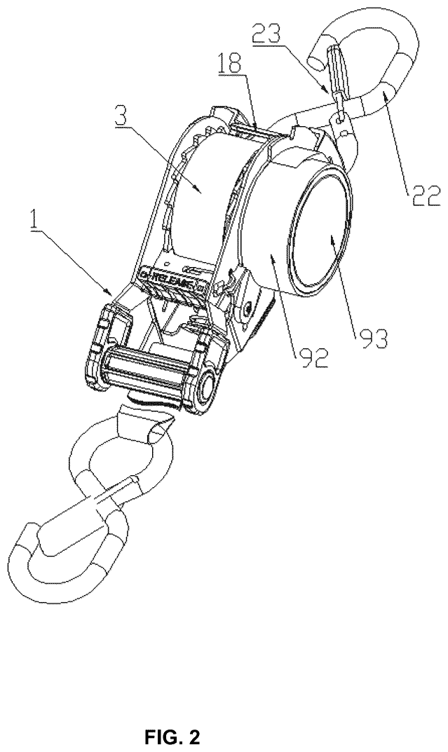

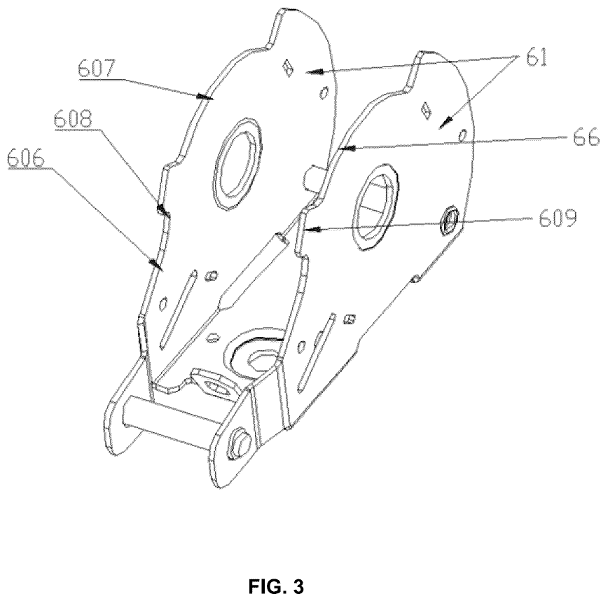

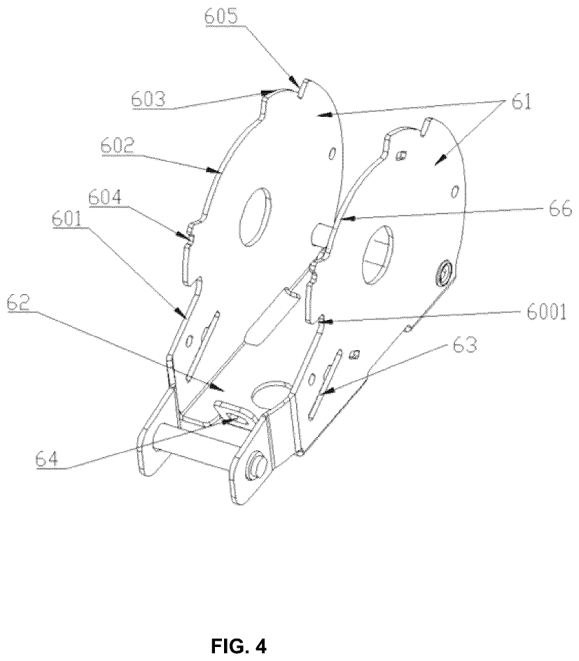

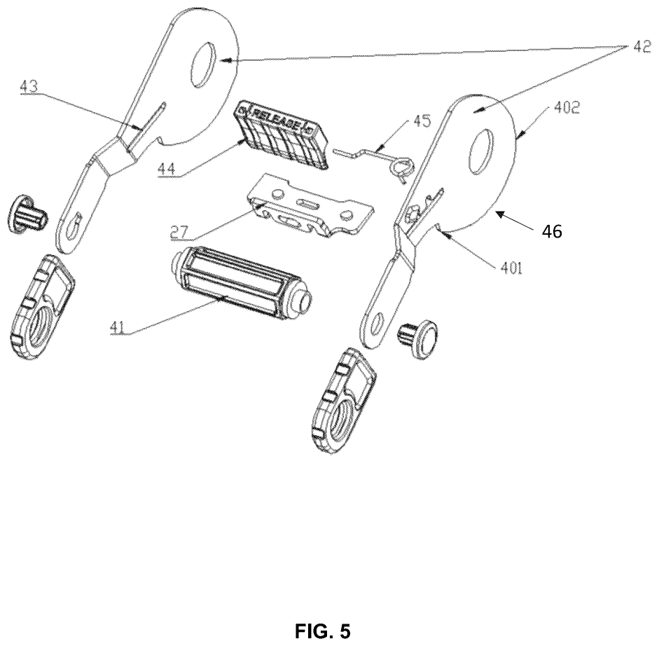

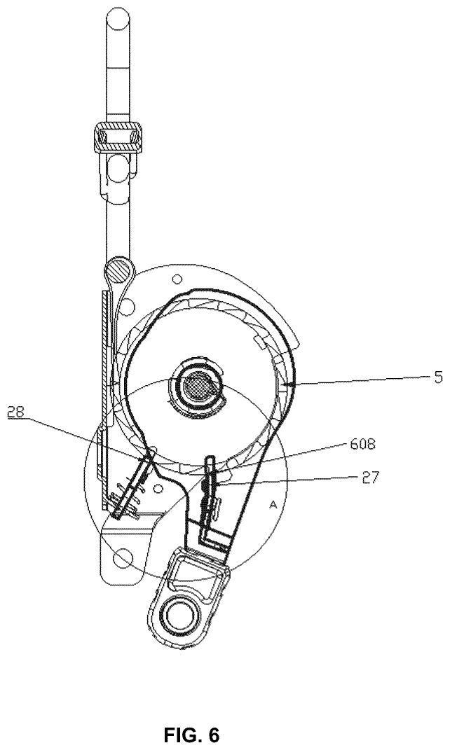

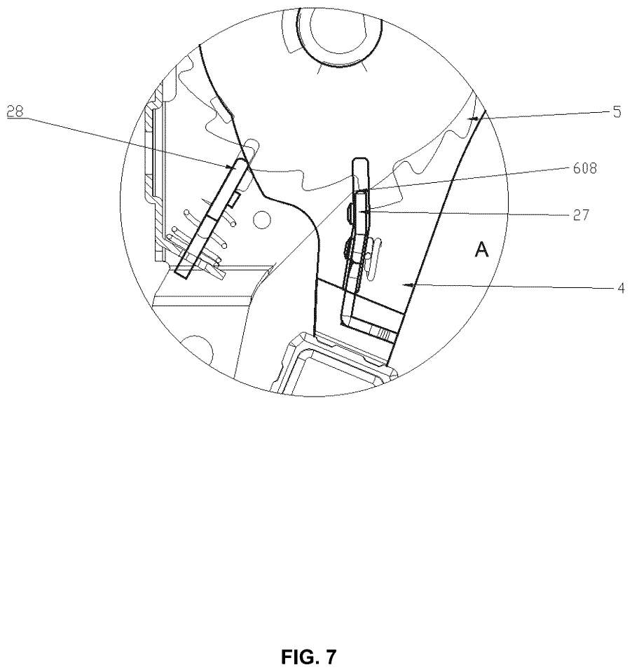

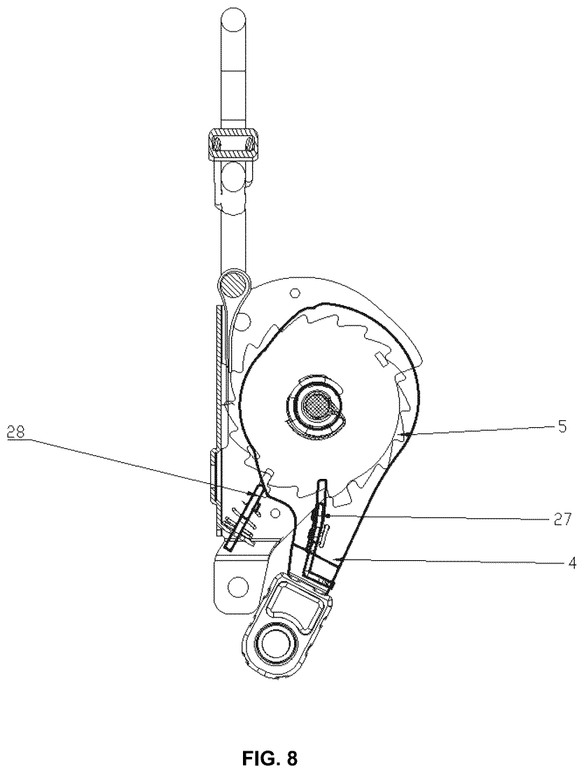

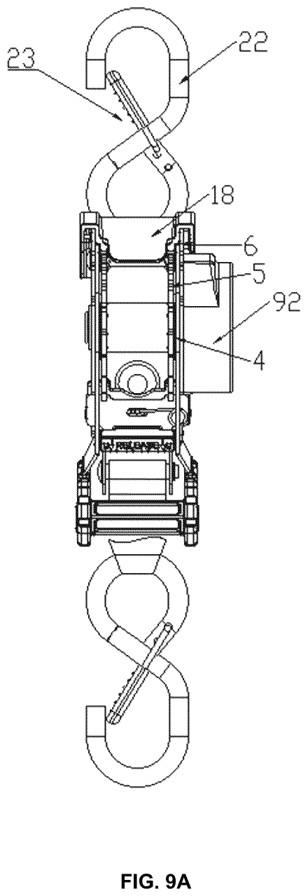

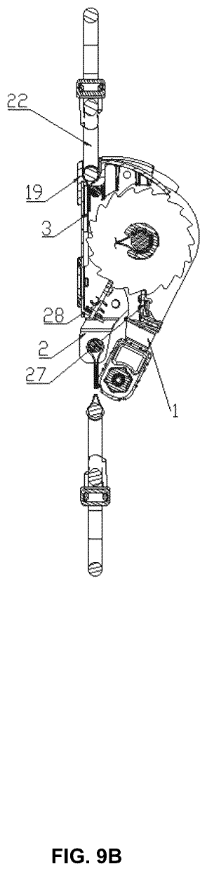

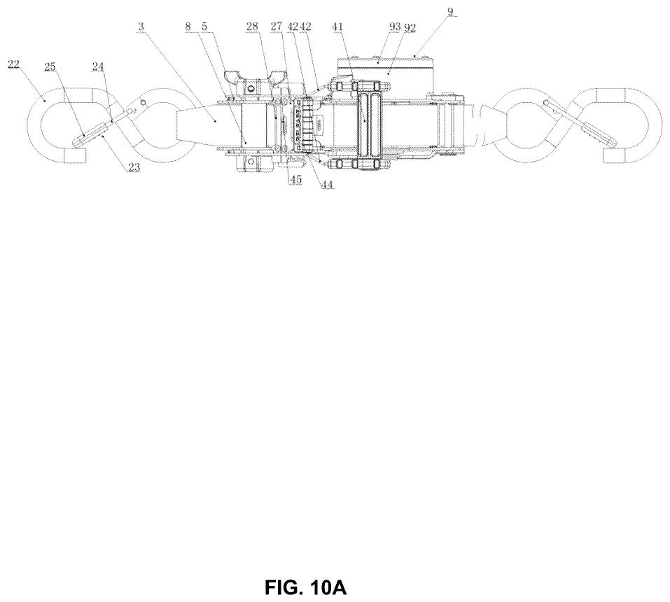

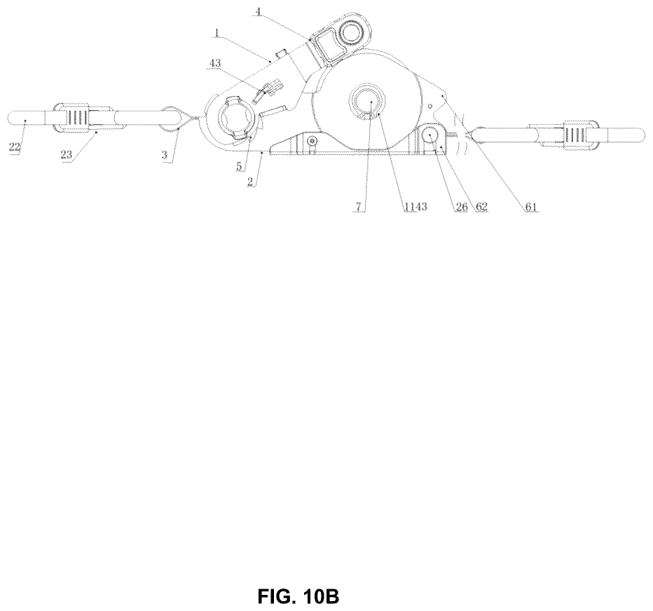

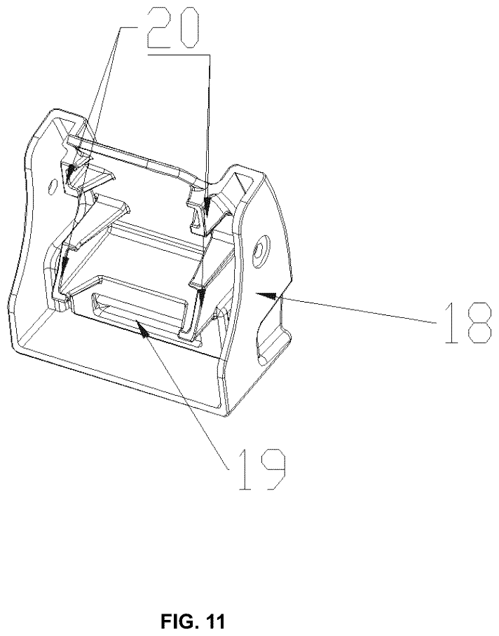

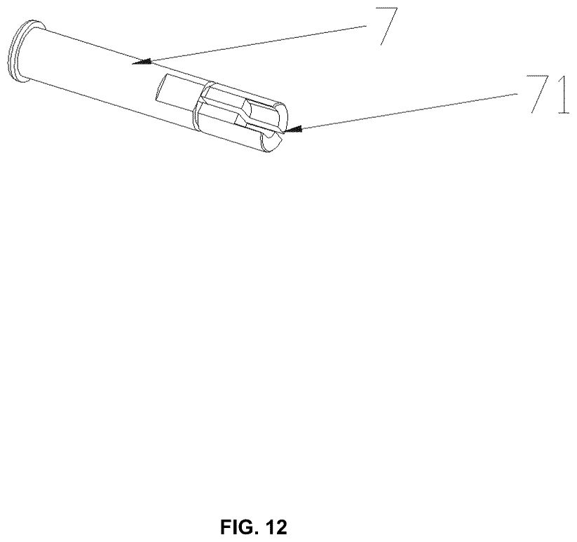

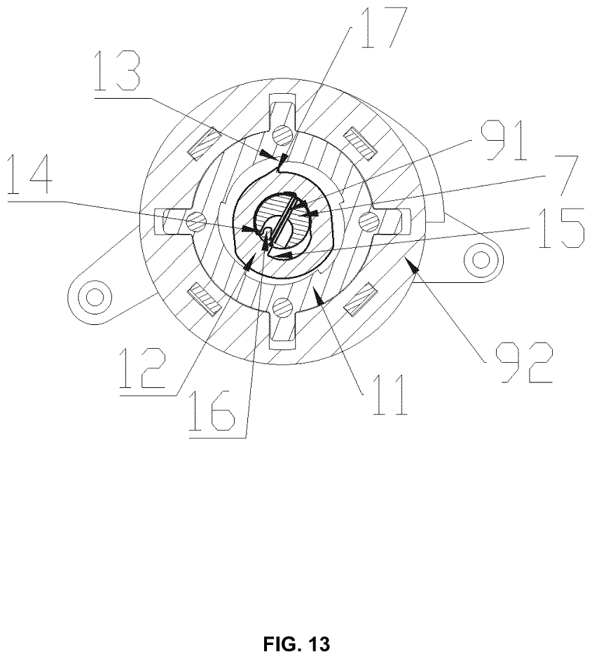

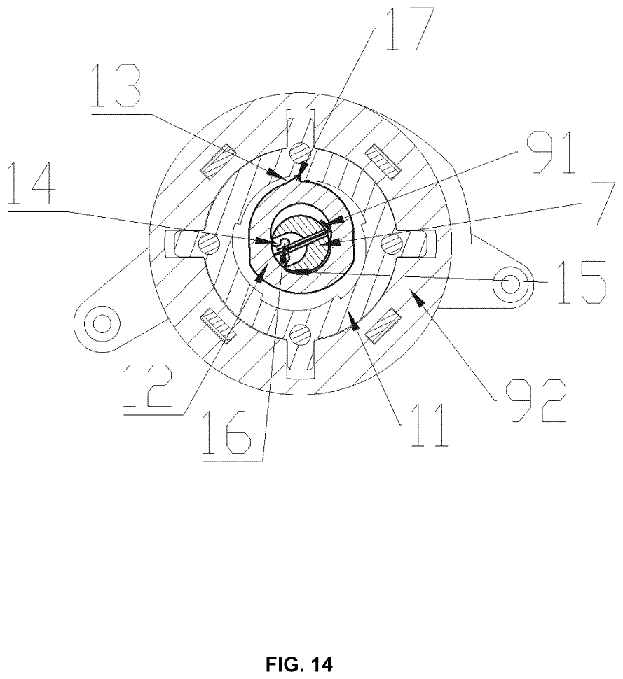

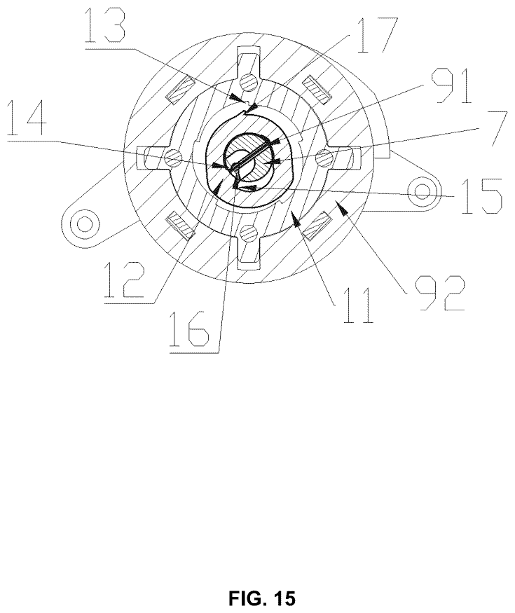

FIG. 1 is an exploded schematic diagram of an exemplary tensioning device according to some embodiments of the present disclosure. FIG. 2 is a schematic diagram of an exemplary combined state of a tensioning device according to some embodiments of the present disclosure. FIG. 3 is a schematic diagram of an exemplary first type of base structure according to some embodiments of the present disclosure. FIG. 4 is a schematic diagram of an exemplary second type of base structure according to some embodiments of the present disclosure. FIG. 5 is a schematic diagram of a structure of an exemplary handle assembly according to some embodiments of the present disclosure. FIG. 6 is a schematic diagram of a working principle of an exemplary locking position in a release zone of a first type of base structure according to some embodiments of the present disclosure. FIG. 7 is a detailed enlargement schematic diagram of part A in FIG. 6. FIG. 8 is a schematic diagram of a working principle of an exemplary release zone of a first type of base structure according to some embodiments of the present disclosure. FIG. 9A is a schematic diagram of a first top view of an exemplary tensioning device according to some embodiments of the present disclosure. FIG. 9B is a schematic diagram of a first cross-section of an exemplary tensioning device according to some embodiments of the present disclosure. FIG. 10A is a schematic diagram of a second top view of an exemplary tensioning device according to some embodiments of the present disclosure. FIG. 10B is a schematic diagram of a second cross-section of an exemplary tensioning device according to some embodiments of the present disclosure. FIG. 11 is a schematic diagram of a structure of an exemplary front cover according to some embodiments of the present disclosure. FIG. 12 is a schematic diagram of a structure of an exemplary reeling shaft according to some embodiments of the present disclosure. FIG. 13 is an internal schematic diagram of an exemplary brake assembly (in an unwinding state) according to some embodiments of the present disclosure. FIG. 14 is an internal schematic diagram of an exemplary brake assembly (in a locked state) according to some embodiments of the present disclosure. FIG. 15 is an internal schematic diagram of an exemplary brake assembly (in a winding state) according to some embodiments of the present disclosure.

As shown in FIG. 1 to FIG. 15, some embodiments of the present disclosure provide a tensioning device for controlling a webbing (hereinafter referred to as a tensioning device), including the handle assembly 1, the base assembly 2, and a long webbing 3, wherein the handle assembly 1 includes a handle 4 and ratchet wheels 5, the base assembly 2 includes the base 6, the handle 4 and the base 6 are pivotally connected with each other through the reeling shaft 7, the ratchet wheels 5 are fixedly mounted on the reeling shaft 7, a reel 8 is fixed between the ratchet wheels 5, the ratchet wheels 5, the reel 8, and the reeling shaft 7 rotate synchronously, the reel 8 is sleeved outside the reeling shaft 7 and disposed coaxially, one side of the reel 8 is provided with an opening 81 for the long webbing 3 to pass through, one end of the long webbing 3 is sleeved on the reeling shaft 7, and the other end of the long webbing 3 is led out from one end of the base 6 through the opening 81 on the reel 8, one end of the reeling shaft 7 is connected to a coiling spring assembly 9, the coiling spring assembly 9 includes a coiling spring 91 and a coiling spring cartridge 92 sleeved on the coiling spring 91.

In some embodiments, the coiling spring assembly 9 further includes a coiling cartridge cover 93, the coiling cartridge cover 93 is disposed on the coiling spring cartridge 92, and the brake assembly 10 is disposed in the coiling spring cartridge 92.

The handle assembly 1 refers to an associated component of the tensioning device used by an operator for operation. The handle 4 refers to a component of the handle assembly 1 used by the operator for operation. The ratchet wheels 5 may be configured to correspondingly cooperate with other components (such as a first pawl 28 and a second pawl 27 mentioned later) to achieve the locking or pulling out of the long webbing 3. In some embodiments, the ratchet wheels 5 include a plurality of gear teeth. The end surfaces of the first pawl 28 and the second pawl 27 may abut against the tips of the gear teeth of the ratchet wheels 5 to fix the ratchet wheels 5, which in turn allows the long webbing 3 to be locked. When the ratchet wheels 5 are pulled to rotate, the long webbing 3 may be pulled out.

The base assembly 2 refers to an associated component of the tensioning device used for supporting and mounting the other components. The base 6 is a core component of the base assembly 2. In some embodiments, the base assembly 2 may be connected to the handle assembly 1. For example, the base 6 may be pivotally connected to the handle 4 through the reeling shaft 7. The term “pivotally connected” refers to a type of rotational connection achieved through a pivot shaft (such as the reeling shaft 7) or a similar structure.

The reeling shaft 7 may be configured to rotationally connect the handle 4 to the base 6. In some embodiments, the ratchet wheels 5 may be fixedly mounted on the reeling shaft 7 by a threaded connection, welding, or the like. For example, the ratchet wheels 5 are fixedly mounted on both ends of the reeling shaft 7 and are located between the handle 4 and the base 6. The reeling shaft 7 may be designed in a variety of structural shapes. In some embodiments, as shown in FIG. 12, one end of the reeling shaft 7 may be provided with a C-shaped opening 71 for better mounting of other members (e.g., a pendulum tooth 12 as described later).

The reel 8 may be configured to wind the long webbing 3. In some embodiments, the reel 8 is sleeved outside the reeling shaft 7 and fixed between the ratchet wheels 5. The reel 8 is provided with an opening 81 for the long webbing 3 to pass through. Structural dimensions (e.g., a width) of the opening 81 may be slightly larger than structural dimensions of the long webbing 3 to allow better passage of the long webbing 3. One end of the long webbing 3 is sleeved on the reeling shaft 7, and the other end is led out from one end of the base 6 through the opening 81 on the reel 8. When the long webbing 3 is wound up, the long webbing 3 retracts and wraps around the reel 8.

The long webbing 3 may be configured to bind and secure objects or goods. Materials of the long webbing 3 include, but are not limited to, polyester, polyester fiber, polypropylene, or the like.

The coiling spring assembly 9 may be configured to provide a continuous rotational torque to the reeling shaft 7 to ensure that the long webbing 3 is automatically wound up and maintains at a certain tension. In some embodiments, the coiling spring assembly 9 may be disposed at one end of the reeling shaft 7 through a threaded connection, a snap connection, or the like. The coiling spring 91 is a resilient element, and the material of the coiling spring 91 may include spring steel, etc. When the reeling shaft 7 is manually rotated, the coiling spring 91 is coiled and stores elastic potential energy. When the reeling shaft 7 is released, the coiling spring 91 releases the stored energy and drives the reeling shaft 7 to rotate in the reverse direction, thereby winding the long webbing 3. The coiling spring cartridge 92 refers to a housing configured to protect and secure the coiling spring 91. The coiling cartridge cover 93 may be configured to further protect the coiling spring 91.

The brake assembly 10 may be configured to limit a rotation of the reeling shaft 7 to prevent the long webbing 3 from automatically reeling back in when it is not needed, ensuring safety and reliability of use. The brake assembly 10 may be in a plurality of structural forms to limit the rotation of the reeling shaft 7. For example, the brake assembly 10 may include an electromagnetic clutch to control the rotation of the reeling shaft 7 by the engagement and release of the electromagnetic clutch. As another example, the brake assembly 10 may include a caliper to control rotation of the reeling shaft 7 by clamping or releasing the reeling shaft 7 through the caliper.

More descriptions regarding the tensioning device may be found in a later description.

In some embodiments, as shown in FIG. 1, FIG. 13-FIG. 15, the brake assembly 10 includes a limit tooth 11 and a pendulum tooth 12, the limit tooth 11 is connected to the coiling spring cartridge 92, a plurality of first internal teeth 13 are disposed on a ring-shaped inner wall of the limit tooth 11 that is close to the reeling shaft 7, a hole is in a center of the pendulum tooth 12, a linkage groove 14 and a brake groove 15 are disposed in the hole, a diagonal over-section 16 is disposed between the linkage groove 14 and the brake groove 15, the pendulum tooth 12 is eccentrically sleeved on the C-shaped opening 71 at the end of the reeling shaft 7, a first outer contour tooth 17 is disposed on an outer side of the pendulum tooth 12 away from the brake groove 15, and the pendulum tooth 12 rotates synchronously with the reeling shaft 7.

The limit tooth 11 may be configured to limit a rotation of the pendulum tooth 12. In some embodiments, the limit tooth 11 may be disposed within the coiling spring cartridge 92 through a snap connection, a threaded connection, or the like. The limit tooth 11 has a ring-like structure and is sleeved on the pendulum tooth 12, and the plurality of the first internal teeth 13 are disposed on the ring-shaped inner wall of the limit tooth 11 that is close to the reeling shaft 7. The limit tooth 11 may control the rotation of the pendulum tooth 12 by the plurality of first internal teeth 13 in contact or not in contact with the pendulum tooth 12. Understandably, a specific count of the first internal teeth 13 may be set according to the actual needs.

The pendulum tooth 12 may control a winding process and a unwinding process of the long webbing 3 by interacting with the limit tooth 11. The pendulum tooth 12 may also provide a braking function by engaging with the limit tooth 11 when a winding speed is too fast. In some embodiments, the pendulum tooth 12 may be in contact or not in contact with the first internal teeth 13 through the first outer contour tooth 17 to control the winding process and unwinding process of the long webbing 3.

The linkage groove 14 is configured to allow the C-shaped opening 71 at the end of the reeling shaft 7 to engage during normal unwinding to ensure that the pendulum tooth 12 rotates in synchronization with the reeling shaft 7. The brake groove 15 is configured to allow the C-shaped opening 71 at the end of the reeling shaft 7 to engage when the winding speed is too fast, thereby triggering the braking function. The diagonal over-section 16 is disposed between the linkage groove 14 and the brake groove 15, and is configured to provide a smooth transition during the winding process.

In some embodiments of the present disclosure, by designing the structure of the limit tooth and the pendulum tooth of the brake assembly, and by cooperating with the C-shaped opening at the end of the reeling shaft, not only the winding process and unwinding process of the long webbing can be realized, but also a braking can be performed when the winding speed is too fast, which can prevent the long webbing from swinging and hurting the operator. This effectively ensures the safety of the winding process and protects the personal safety of the operator. Moreover, the brake assembly is compact, taking up little space and having a low cost.

In some embodiments, as shown in FIG. 1, FIG. 3-FIG. 4, the base 6 includes a base side plate 61 and a base bottom plate 62, an upper side curved surface 66 of the base side plate 61 is divided into a release zone 606 and a tensioning working zone 607 in turn. In some embodiments, the base side plate 61 and the base bottom plate 62 are of one-piece construction, and the base side plate 61 is perpendicular to the base bottom plate 62 and symmetrically disposed on both sides of the base bottom plate 62. In some embodiments, a first pawl sliding groove 63 is disposed at a rear side of the base side plate 61, a first limiting plate 64 is disposed at a rear side of the base bottom plate 62, the first pawl sliding groove 63 is provided with a first pawl 28, the first pawl 28 is T-shaped, both ends of the first pawl 28 are slidably disposed at the first pawl sliding groove 63, a first reset spring 65 is sleeved on a lower end of the first pawl 28, which is inserted into the first limiting plate 64 and slidably matched with the first limiting plate 64; and the first pawl 28 elastically slides in a direction of the first pawl sliding groove 63 under an action of the first reset spring 65, and the first pawl 28 is correspondingly cooperated with the ratchet wheels 5.

The base side plates 61 are portions of the two sides of the base 6 for supporting and securing other components (e.g., the reeling shaft 7, etc.). In some embodiments, the upper side curved surface 66 of the base side plate 61 is provided with a first protrusion 609, the first protrusion 609 dividing the upper side curved surface 66 of the base side plate 61 into the release zone 606 and the tensioning working zone 607.

The base bottom plate 62 is a bottom portion of the base 6 for supporting the base 6. It should be noted that the base side plate 61 and the base bottom plate 62 may also be connected by any other feasible means. For example, the base side plate 61 and the base bottom plate 62 may be connected by means of bonding, welding, snap connections, or the like.

The first pawl sliding groove 63 is a slot aperture disposed on the base side plate 61. In some embodiments, the first pawl sliding groove 63 is symmetrically disposed on the base side plate 61 for guiding a sliding of the first pawl 28. Understandably, structural dimensions of the first pawl sliding groove 63 may be set according to actual needs.

The first pawl 28 may be configured to cooperate with the ratchet wheels 5 to prevent the reverse rotation of the reeling shaft 7, thereby enabling the locking or pulling out of the long webbing 3.

The first limiting plate 64 may be configured to limit a sliding range of the first pawl 28 to prevent it from sliding excessively. In some embodiments, one end of the first limiting plate 64 may be fixedly connected to a rear side of the base bottom plate 62, and the other end extends in a direction away from the base bottom plate 62. The first limiting plate 64 is provided with a through hole, through which a lower end of the first pawl 28 can pass. At this time, one end of the first reset spring 65, which is sleeved on the lower end of the first pawl 28, abuts against the first limiting plate 64, while the other end abuts against an upper end of the first pawl 28.

The first reset spring 65 may be configured to provide a reset force for the first pawl 28. For example, after releasing a downward pressure on the handle, the first reset spring 65, which is engaged between the first limiting plate 64 and the upper end of the T-shaped first pawl 28, returns to its original shape, thereby providing the reset force for the first pawl 28 and enabling it to automatically return to the initial position.

In some embodiments, as shown in FIG. 1, FIG. 5, the handle 4 includes a handgrip 41 and handle side plates 42, the handle side plates 42 are connected to the handgrip 41 and symmetrically disposed on both sides of the handgrip 41, the handle side plates 42 are coaxially rotationally connected to the base side plate 61 through a sleeve 1143, the sleeve 1143 is connected with the reeling shaft 7 so that the handle side plates 42 are freely rotatable with the reeling shaft 7 as a central axis, the handle side plates 42 are provided with symmetrical second pawl slide grooves 43, the second pawl slide grooves 43 are provided with a second pawl 27, the second pawl 27 is L-shaped, a plastic sleeve 44 is disposed at an upper end of the second pawl 27, and two ends of the second pawl 27 are slidably disposed at the second pawl slide grooves 43, the second pawl 27 is connected to one side of one of the handle side plates 42 by a torsion spring 45; and the second pawl 27 elastically slides in a direction of each of the second pawl slide grooves 43 under an action of the torsion spring 45, and the second pawl 27 is correspondingly cooperated with the ratchet wheels 5.

The handle 41 is a main portion of the handgrip 4 for the operator to hold and operate. The handle side plates 42 are portions of the two sides of the handle 4 for supporting and securing other components (e.g., the second pawl 27, etc.). In some embodiments, the handle side plate 42 may be connected to the handgrip 41 through a snap connection, bonding, etc.

The sleeve 1143 is a connecting component that may be used not only to realize a coaxial rotational connection between the handle side plate 42 and the reeling shaft 7, but also to realize a free rotation of the handle side plate 42 with the reeling shaft 7 as the central axis.

The second pawl slide groove 43 is a slot aperture disposed on the handle side plate 42. In some embodiments, the second pawl slide groove 43 may be configured to guide a sliding of the second pawl 27. Understandably, structural dimensions of the second pawl slide groove 43 may be set according to actual needs.

The second pawl 27 is also configured to cooperate with the ratchet wheels 5 to prevent the reverse rotation of the reeling shaft 7, thereby enabling the locking or pulling out of the long webbing 3. The plastic sleeve 4 is disposed at the upper end of the second pawl 27 to facilitate operation by the operator.

The torsion spring 45 may be configured to connect the second pawl 27 to the handle side plate 42. In some embodiments, the torsion spring 45 may also be configured to provide a reset force for the second pawl 27. For example, after releasing the downward pressure on the handle, the torsion spring 45, which connects the second pawl 27 to the handle side plate 42, returns to its original shape, thereby providing the reset force for the second pawl 27 and enabling it to automatically return to the initial position.

In some embodiments, the two ends of the second pawl 27 extend out of the second pawl slide groove 43 and fit in the upper side curved surface 66 of the base side plate 61 under the action of the torsion spring 45.

In some embodiments, as shown in FIG. 5, a first squeezing surface 401 and a second squeezing surface 402 for squeezing the first pawl 28 are disposed on a lower side curved surface 46 of the handle side plate 42. Both the first squeezing surface 401 and the second squeezing surface 402 may be configured to squeeze the first pawl 28 to disengage the first pawl 28 from the ratchet wheels 5. It should be noted that structural forms of the first squeezing surface 401 and the second squeezing surface 402 may be designed according to the actual application requirements.

In some embodiments, as shown in FIG. 9-FIG. 11, a front cover 18 is disposed on one end of the base 6 close to the long webbing 3, the front cover 18 is provided with a webbing channel 19 for the long webbing 3 to pass through and provided with symmetrical limit walls 20, and a bottom of the base 6 is provided with symmetrical limit ports 21 that are strip-shaped, the limit walls 20 and the limit ports 21 cooperating for limiting the handle 4. When the handle assembly 1 is rotated, the handle side plate 42 may move under the restriction effect of the limit walls 20 and the limit ports 21, and interference between the side surface of the handle 4 and the side surfaces of the ratchet wheels 5 and the base 6 may be effectively avoided. With such a configuration, on the one hand, the smoothness of the tensioning device during operation is improved, making it easier and more effort-saving to use; on the other hand, it can reduce the deformation of the handle 4 caused by use, reduce friction, and increase the service life of the tensioning device.

In some embodiments of the present disclosure, the base has a simple structure. By positioning the handle on the upper side curved surface of the base side plate, the rapid winding of the long webbing can be manually controlled, while also facilitating manufacturing and reducing production costs.

In some embodiments, as shown in FIG. 9A-FIG. 10B, the long webbing 3 is connected with a hook 22, the front cover 18 is disposed at one end of the base 6, the webbing channel 19 on the front cover 18 extends toward the other end of the base 6, and the webbing channel 19 is in a constricted shape and is configured to catch one end of the hook 22. It should be understood that the webbing channel 19 is designed as a groove shape and has a certain longitudinal depth. When the long webbing 3 is completely wound up, one end of the hook 22 on the long webbing 3 may be engaged into the webbing channel 19 to play the role of fixing the hook 22, thus preventing the hook 22 from shaking and reducing safety hazards. It should be noted that the hook 22 may be replaced with any other feasible structural form. For example, the hook 22 may be replaced with a snap structure, etc.

In some embodiments, as shown in FIG. 1-FIG. 2, FIG. 9A-FIG. 10B, a safety mechanism 23 is disposed at an opening of the hook 22, the safety mechanism 23 includes a return-action spring 24 and a safety sleeve 25. The return-action spring 24 is mounted on the hook 22 and has an elastic force that tends to bring it closer to the opening of the hook 22. The safety sleeve 25 is disposed on the return-action spring 24 and elastically closes the opening of the hook 22 under an action of the return-action spring 24.

The safety mechanism 23 may be configured to prevent the hook 22 from accidentally detaching in a fixed state to increase the safety of use. It should be noted that the safety mechanism 3 may also adopt any other feasible structural form, including but not limited to a combination structure of a magnet and a metal sheet, a mechanical latch structure, and the like.

In some embodiments of the present disclosure, by providing the safety mechanism at the opening of the hook, the hook can be prevented from accidentally detaching in a fixed state, and the safety of use can be increased.

In some embodiments, as shown in FIG. 1, a detachable connecting shaft 26 is disposed on an end of the base 6 opposite to the long webbing 3, and the detachable connecting shaft 26 is connected with at least one of a short webbing, a hooklet, a snap, or a fixed plate, as well as other fasteners that play a role in securing. Exemplary removable connections include, but are not limited to, snap connections, threaded connections, and the like.

In some embodiments, the tensioning device operates as follows.

When cargo securing is performed, by rotating the handle 4, the position of the second pawl 27 on the upper side curved surface 66 (the release zone 606, the first protrusion 609, the tensioning working zone 607) of the base side plate 61 is adjusted, thereby achieving manual locking of the long webbing 3 and the adjustment function of the tensioning device.

As shown in FIG. 6 and FIG. 7, when the second pawl 27 is located in a locking position 608 of the release zone 606, at this time, the end surfaces of the first pawl 28 and the second pawl 27 abut against the tips of the gear teeth of the ratchet wheels 5, and the ratchet wheel 5 are fixed, and the long webbing 3 is locked. When the force applied to the long webbing 3 is greater than the elastic force of the first reset spring 65 and the torsion spring 45, the ratchet wheels 5 may be pulled to rotate and the long webbing 3 may be pulled out.

As shown in FIG. 8, when the handle 4 is rotated downward, the second pawl 27 moves downward along the release zone 606, at which time, a distance between the second pawl 27 and the axis of rotation of the ratchet wheels 5 increases, and the second pawl 27 is disengaged from the ratchet wheels 5, and, at the same time, the first squeezing surface 401 squeezes the first pawl 28, so that a distance between the first pawl 28 and the axis of rotation of the ratchet wheels 5 increases, and the first pawl 28 is disengaged from the ratchet wheels 5. In this state, the long webbing 3 may be quickly adjusted, but the handle 4 must be continuously pressed, or else, once the pressing force is released, the first pawl 28 and the second pawl 27 will be urged upward by the action of the first reset spring 65 and the torsion spring 45, respectively, forcing the handle 4 to return to its original position. As a result, the first pawl 28 and the second pawl 27 re-abut against the tips of the gear teeth of the ratchet wheels 5 to stop the long webbing 3, and in this state, the rapid retraction of the long webbing 3 may be manually controlled.

When the second pawl 27 is located in the tensioning working zone 607, both the first pawl 28 and the second pawl 27 are engaged with the ratchet wheels 5, and the second pawl 27 is not in contact with the tensioning working zone 607. By rotating the handle 4 counterclockwise, the second pawl 27 moves along the tensioning working zone 607, driving the ratchet wheels 5 to rotate, and the first pawl 28 slides along the outer edge of the ratchet wheels 5. When the handle 4 is rotated to the limit position of the tensioning working zone 607, the handle 4 may be rotated clockwise, the second pawl 27 slides along the outer edge of the ratchet wheels 5, the first pawl 28 engages with the ratchet wheels 5, and the handle 4 is reset. By repeatedly rotating the handle 4 in counterclockwise and clockwise directions, the long webbing 3 may be manually wound up, which also serves to increase the tension of the long webbing 3 and achieve a tightening effect.

After use, when it is necessary to retract the long webbing 3, the handle 4 is first rotated to move the second pawl 27 from the tensioning working zone 607 to the position of the first protrusion 609; at this point, the device is in a pre-release state. When the handle 4 is fully pressed down, the first pawl 28 and the second pawl 27 disengage from the ratchet wheels 5, and under the action of the coiling spring 91, the long webbing 3 is automatically wound up. At this time, releasing the downward force on the handle 4 will stop the long webbing 3 from moving further.

When the long webbing 3 is normally unwound, the reeling shaft 7 drives the pendulum tooth 12 to rotate, at which time the C-shaped opening 71 at the end of the reeling shaft 7 engaged into the linkage groove 14, and the first outer contour tooth 17 of the pendulum tooth 12 does not contact the first internal teeth 13 of the limit tooth 11, and the long webbing 3 may be continually unwound (as shown in FIG. 13). When the long webbing 3 is wound up, the C-shaped opening 71 at the end of the reeling shaft 7 continuously abuts against the diagonal over-section 16, causing the first outer contour tooth 17 of the pendulum tooth 12 away from the first internal teeth 13 of the limit tooth 11, and the long webbing 3 may be continuously wound (as shown in FIG. 15). However, when the winding speed is too fast, the pendulum tooth 12, under the action of impact rebound and inertial centrifugal force, causes the C-shaped opening 71 of the reeling shaft 7 to engage into the brake groove 15, at which time, the first outer contour tooth 17 of the pendulum tooth 12 engages the first internal teeth of the limit tooth 11, the brake assembly 10 is in a braking state, and the winding of the long webbing 3 is locked (as shown in FIG. 14). Until the long webbing 3 is pulled out a certain length, the first outer contour tooth 17 of the pendulum tooth 12 are disengaged from the first internal teeth 13 of the limit tooth 11, and the long webbing 3 may be wound up.

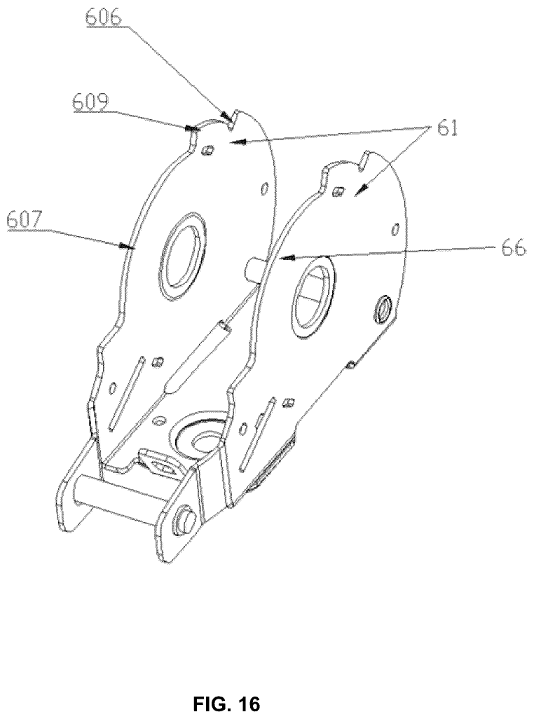

FIG. 16 is a schematic diagram of a structure of an exemplary first type of base structure according to some other embodiments of the present disclosure.

Some embodiments of the present disclosure also provide an alternative embodiment of the first type of the base. As shown in FIG. 16, the upper side curved surface 66 of the base side plate 61 is provided with the first protrusion 609, the first protrusion 609 dividing the upper side curved surface 66 of the base side plate 61 into the release zone 606 and the tensioning working zone 607.

When cargo securing is performed, by rotating the handle 4, the position of the second pawl 27 on the upper side curved surface 66 (the release zone 606, the first protrusion 609, the tensioning working zone 607) of the base side plate 61 is adjusted, thereby achieving manual locking of the webbing and the adjustment function of the tensioning device.

When the second pawl 27 is located in the release zone 606, the second pawl 27 is disengaged from the ratchet wheels 5, and at this time, the second squeezing surface 402 squeezes the first pawl 28 so that the first pawl 28 is disengaged from the ratchet wheels 5, and at this time, an extracting force is applied on the long webbing 3 and the long webbing 3 may be pulled out.

When the handle 4 is pressed downward, the second pawl 27 moves downwardly along the first protrusion 609 to reach the tensioning working zone 607, at which time the first pawl 28 and the second pawl 27 are engaged with the ratchet wheels 5, and the second pawl 27 and the tensioning working zone 607 do not in contact. Then when the handle 4 is rotated downward, the second pawl 27 moves along the tensioning working zone 607, driving the ratchet wheels 5 to rotate, and the first pawl 28 slides along the outer edge of the ratchet wheels 5. When the handle 4 is rotated to the limit position of the tensioning working zone 607, the handle 4 may be rotated in the clockwise, the second pawl 27 slides along the outer edge of the ratchet wheels 5, the first pawl 28 engages with the ratchet wheels 5, and the handle 4 is reset. By repeatedly rotating the handle 4, the long webbing 3 may be manually wound up, which also serves to increase the tension of the long webbing 3 and achieve a tightening effect.

After use, when it is necessary to retract the long webbing 3, the handle 4 is rotated to move the second pawl 27 from the tensioning working zone 607 to the position of the release zone 606, the first pawl 28 and the second pawl 27 are disengaged from the ratchet wheels 5, and, under the action of the coiling spring 91, the long webbing 3 is automatically wound up.

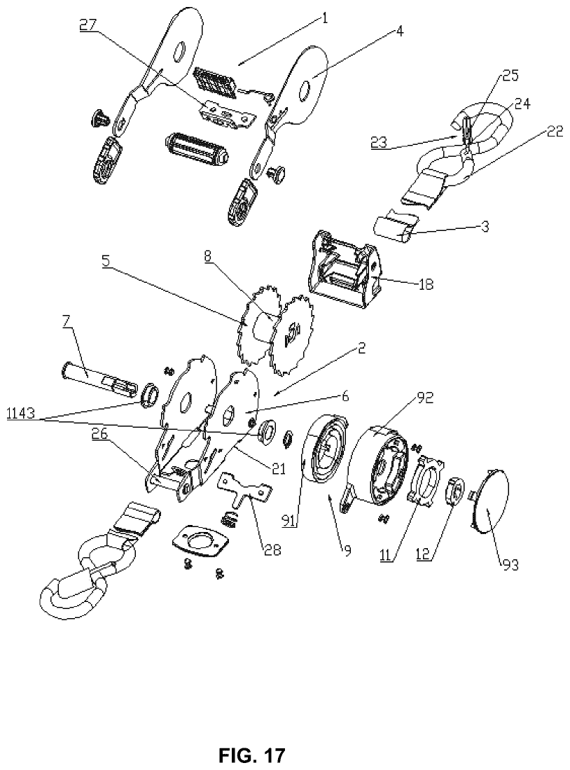

FIG. 17 is an exploded schematic diagram of an exemplary tensioning device according to some other embodiments of the present disclosure.

Some embodiments of the present disclosure also provide a tensioning device. The difference with the foregoing tensioning device is that the base 6 of the tensioning device adopts a second type of base, as shown in FIG. 4, FIG. 17, and the upper side curved surface 66 of the base side plate 61 is further divided into an unloading section 601, a tightening section 602, and a releasing section 603 in turn, a first locking port 604 being disposed between the unloading section 601 and the tightening section 602, and a second locking port 605 being disposed at an end of the releasing section 603.

When cargo securing is performed, by rotating the handle 4, the position of the second pawl 27 on the upper side curved surface 66 (the unloading section 601, the first locking port 604, the tightening section 602, the releasing section 603, and the second locking port 605) of the base side plate 61 is adjusted, thereby achieving manual locking of the long webbing 3 and the adjustment function of the tensioning device.

When the second pawl 27 is located in a first position 6001 of the unloading section 601, at this time, the end surfaces of the first pawl 28 and the second pawl 27 abut against the tips of the gear teeth of the ratchet wheels 5 to fix the ratchet wheels 5, which in turn allows the long webbing 3 to be locked. When the force applied to the long webbing 3 is greater than the elastic force of the first reset spring 65 and the torsion spring 45, the ratchet wheels 5 may be pulled to rotate and the long webbing 3 may be pulled out.

When the second pawl 27 is located in the unloading section 601, the handle 4 may be pressed down, and when the handle 4 is rotated downward, the second pawl 27 moves downward along the unloading section 601, at which time, a distance between the second pawl 27 and the axis of rotation of the ratchet wheels 5 increases, and the second pawl 27 is disengaged from the ratchet wheels 5, and at the same time, the first squeezing surface 401 squeezes the first pawl 28, so that the distance between the first pawl 28 and the axis of rotation of the ratchet wheels 5 increases, and the first pawl 28 is disengaged from the ratchet wheels 5. At this time, under the action of the coiling spring 91, the reeling shaft 7 and the ratchet wheels 5 rotate to drive the long webbing 3 to be wound up. In this state, the long webbing 3 may be quickly adjusted, but the handle 4 must be continuously pressed, or else, once the pressing force is released, the first pawl 28 and the second pawl 27 will be urged upward by the action of the first reset spring 65 and the torsion spring 45, respectively, forcing the handle 4 to return to its original position. so that the first pawl 28 and the second pawl 27 are re-abutted against the tops of the gear teeth of the ratchet wheels 5 to stop the long webbing 3, and the long webbing 3 may be manually controlled to be rapidly retracted in this state.

When the second pawl 27 is located at the first locking port 604, the second pawl 27 is engaged with the first locking port 604, at this time, the handle 4 is not rotatable, preventing accidental operation, the second pawl 27 is disengaged from the ratchet wheels 5, the first pawl 28 engages with the ratchet wheels 5, the ratchet wheels 5 are not rotatable, and the tensioning device is in a safe locked state;

When the second pawl 27 is located in the tightening section 602, both the first pawl 28 and the second pawl 27 are engaged with the ratchet wheels 5, and the second pawl 27 is not in contact with the tightening section 602 (to ensure that the second pawl 27 engages with the ratchet wheels 5 and to prevent the second pawl 27 from rubbing against the tightening section 602, resulting in an increase in the resistance to rotation of turning the handle 4). By rotating the handle 4 counterclockwise, the second pawl 27 moves along the tightening section 602, driving the ratchet wheels 5 to rotate, the first pawl 28 slides along the outer edge of the ratchet wheels 5. When the handle 4 is rotated to the limit position of the tightening section 602, the handle 4 may be rotated clockwise, the second pawl 27 slides along the outer edge of the ratchet wheels 5, the first pawl 28 engages with the ratchet wheels 5, and the handle 4 is reset. By repeatedly rotating the handle 4 in counterclockwise and clockwise directions, the long webbing 3 may be manually wound up, which also serves to increase the tension of the long webbing 3 and achieve a tightening effect.

When the second pawl 27 is located in the releasing section 603, the second pawl 27 is disengaged from the ratchet wheels 5, and the handle 4 is continuously rotated counterclockwise until the second pawl 27 engages into the second locking port 605, at which time the second squeezing surface 402 squeezes the first pawl 28 so that the first pawl 28 disengage from the ratchet wheels 5, and the long webbing 3 is automatically wound up under the action of the coiling spring 91.

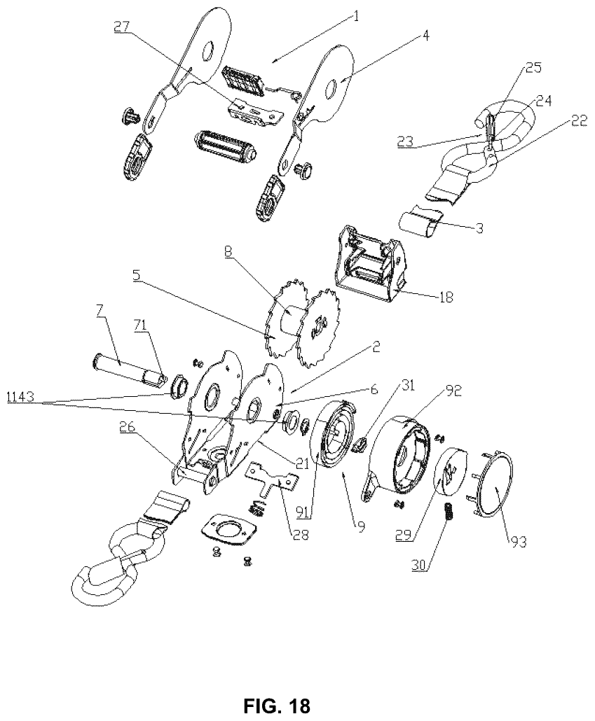

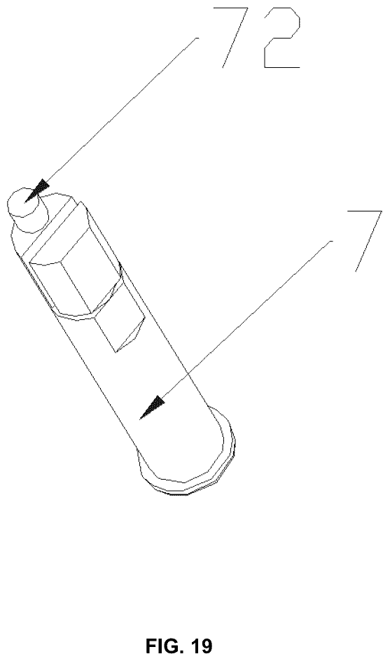

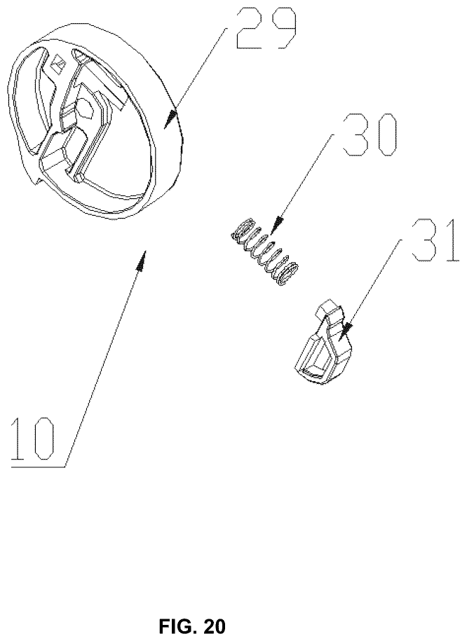

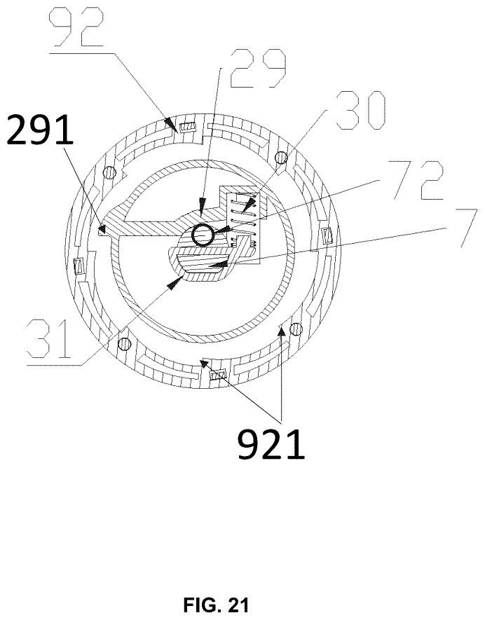

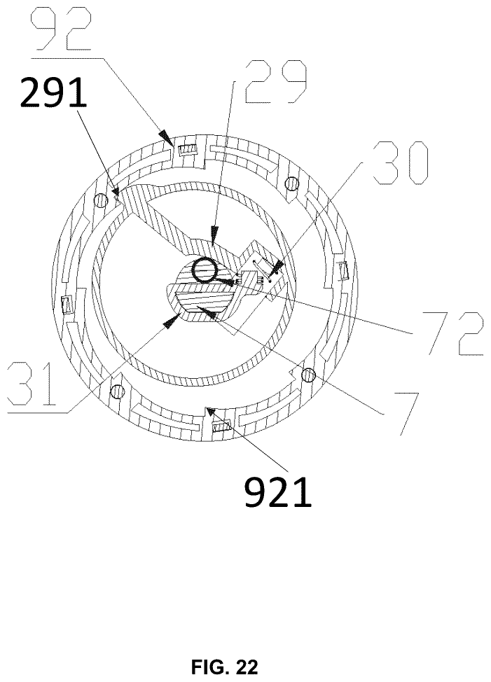

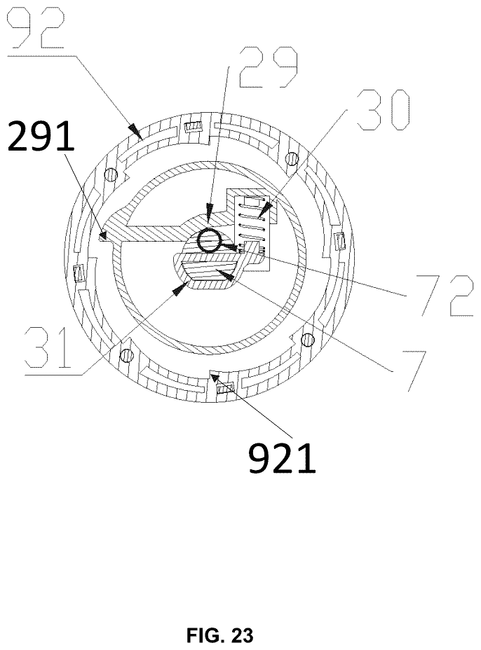

FIG. 18 is an exploded schematic diagram of an exemplary tensioning device according to some other embodiments of the present disclosure. FIG. 19 is a schematic diagram of a structure of an exemplary reeling shaft according to some other embodiments of the present disclosure. FIG. 20 is a schematic diagram of a structure of an exemplary brake assembly according to some other embodiments of the present disclosure. FIG. 21 is an internal schematic diagram of an exemplary brake assembly (in an unwinding state) according to some other embodiments of the present disclosure. FIG. 22 is an internal schematic diagram of an exemplary brake assembly (in a locked state) according to some other embodiments of the present disclosure. FIG. 23 is an internal schematic diagram of an exemplary brake assembly (in a winding state) according to some other embodiments of the present disclosure.

Some embodiments of the present disclosure also provide a tensioning device. As shown in FIG. 18-FIG. 23, the difference from the foregoing tensioning device is that, in this tensioning device, a first eccentric shaft 72 is disposed at one end of the reeling shaft 7, and the brake assembly 10 includes a locking pawl 29, a spring 30, and a fixing member 31, the fixing member 31 is connected to the reeling shaft 7, the fixing member 31 rotates synchronously with the reeling shaft 7, a second outer contour tooth 291 is disposed on an outer periphery of the locking pawl 29 close to the coiling spring cartridge 92, the locking pawl 29 is connected to the first eccentric shaft 72 at the end of the reeling shaft 7, the spring 30 is disposed between the locking pawl 29 and the fixing member 31, one end of the spring 30 is connected to the fixing member 31, and the other end of the spring is connected to the locking pawl 29 to provide a force for the locking pawl 29 to close toward the reeling shaft 7; and a plurality of second internal teeth 921, which are consecutive and circumferentially arranged, are disposed on a ring-shaped inner wall of the coiling spring cartridge 92 facing the locking pawl 29.

In this embodiment, the spring 30 and the fixing member 31 may be replaced with a torsion spring structure, with one end of the torsion spring connected to the reeling shaft 7 and the other end of the torsion spring connected to the locking pawl 29. It should be noted that the specific count of the second internal teeth 921 may be set according to the actual needs.

When the long webbing 3 is normally unwound, the reeling shaft 7 and the first eccentric shaft 72 at the end of the reeling shaft 7 drive the locking pawl 29 to rotate. When the unwinding speed is slow, the locking pawl 29 will not be thrown away due to the elastic force of the spring 30. When the unwinding speed is too fast, the centrifugal force generated exceeds the elastic force of the spring 30, causing the locking pawl 29 to be thrown away, according to the principle of the ratchet wheels, at this time, the second outer contour tooth 291 of the locking pawl comes into contact with the second internal teeth 921 of the coiling spring cartridge 92, but they do not engage, allowing the long webbing 3 to be continuously unwound (as shown in FIG. 21). When the long webbing 3 is wound up, the reeling shaft 7 and the first eccentric shaft 72 at the end of the reeling shaft 7 drive the locking pawl 29 to rotate in the other direction, and when the winding speed is slow, the centrifugal force generated does not exceed the elastic force of the spring 30, the locking pawl 29 is not thrown away, and the second outer contour tooth 291 of the locking pawl 29 does not contact the second internal teeth 921 of the coiling spring cartridge 92, and the long webbing 3 may be continuously wound up (as shown in FIG. 23). When the winding speed is too fast, the generated centrifugal force exceeds the elastic force of the spring 30, the locking pawl 29 is thrown away, the second outer contour tooth 291 of the locking pawl 29 engages with the second internal teeth 921 on the coiling spring cartridge 92, the brake assembly 10 is in a braking state, the reeling shaft 7 cannot rotate, and the winding of the long webbing 3 is locked (shown in FIG. 22). After locking, only a short section of the long webbing 3 needs to be pulled out, the locking pawl 29 is reset by the elastic force of the spring 30, and the second outer contour tooth 291 of the locking pawl 29 is disengaged from the second internal teeth 921 on the coiling spring cartridge 92, and the long webbing 3 may be wound up.

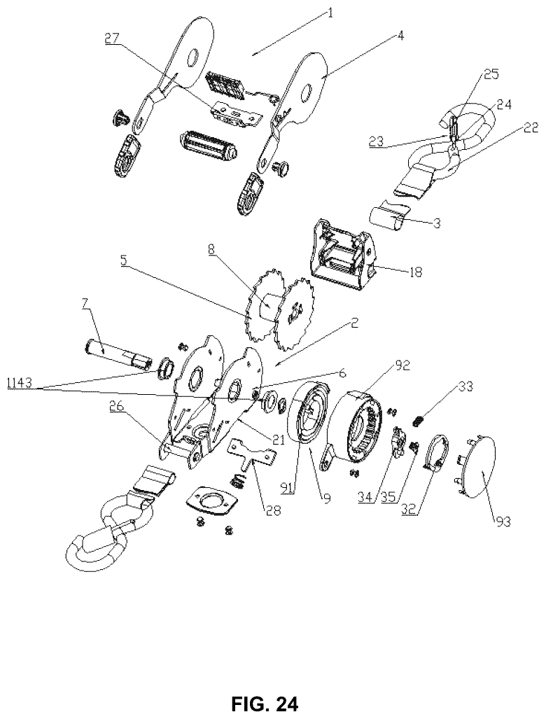

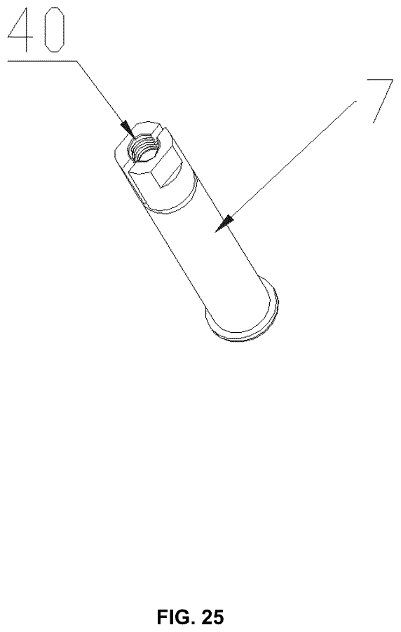

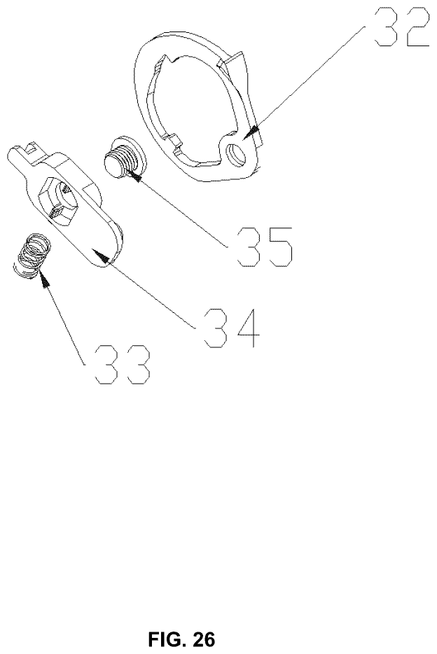

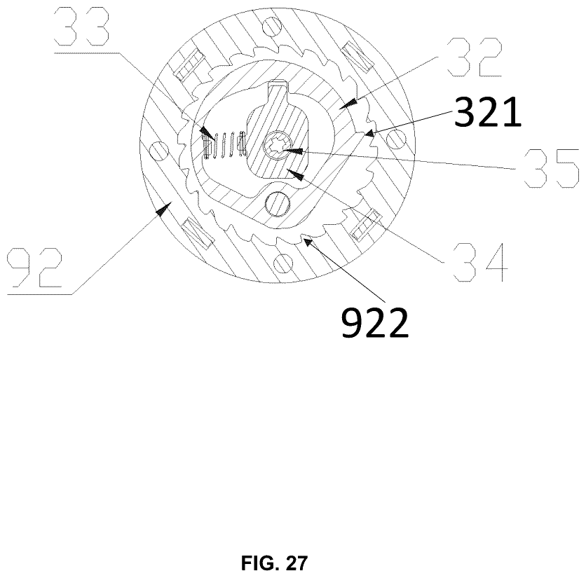

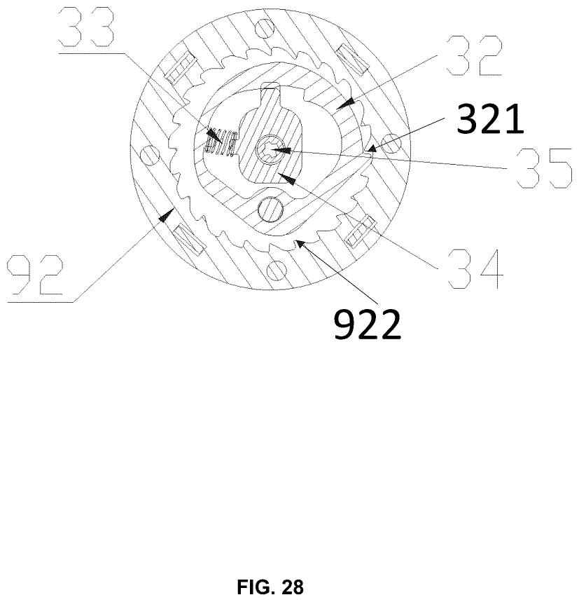

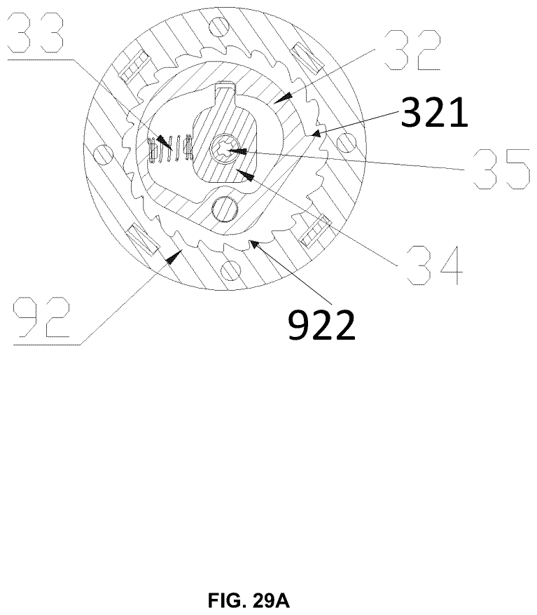

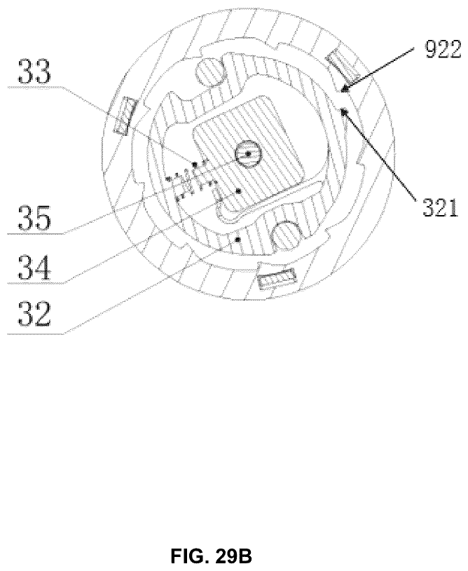

FIG. 24 is an exploded schematic diagram of an exemplary tensioning device according to some other embodiments of the present disclosure. FIG. 25 is a schematic diagram of a structure of an exemplary reeling shaft according to some other embodiments of the present disclosure. FIG. 26 is a schematic diagram of a structure of an exemplary brake assembly according to some other embodiments of the present disclosure. FIG. 27 is an internal schematic diagram of an exemplary brake assembly (in an unwinding state) according to some other embodiments of the present disclosure. FIG. 28 is an internal schematic diagram of an exemplary brake assembly (in a locked state) according to some other embodiments of the present disclosure. FIG. 29A is an internal schematic diagram of an exemplary brake assembly (in a first winding state) according to some other embodiments of the present disclosure. FIG. 29B is an internal schematic diagram of an exemplary brake assembly (in a second winding state) according to some other embodiments of the present disclosure.

Some embodiments of the present disclosure also provide a tensioning device. As shown in FIG. 24-FIG. 29B, the difference from the foregoing tensioning device is that, in this tensioning device, an end of the reeling shaft 7 is provided with a concentric screw hole 40, and the brake assembly 10 includes a brake pawl 32, a return spring 33, a limiting disk 34, and a screw 35, the limiting disk 34 is fixed at the end of the reeling shaft 7 by matching the screw 35 with the concentric screw hole 40, the limiting disk 34 rotates synchronously with the reeling shaft 7, a third outer contour tooth 321 is disposed on an outer periphery of the brake pawl 32 close to the coiling spring cartridge 92, the brake pawl 32 is connected to the limiting disk 34, the return spring 33 is disposed between the brake pawl 32 and the limiting disk 34, one end of the return spring 33 is connected to the limiting disk 34, and the other end of the return spring 33 is connected to the brake pawl 32 to provide a force for the brake pawl 32 to close toward the reeling shaft 7; and a plurality of third internal teeth 922, which are consecutive and circumferentially arranged, are disposed on a ring-shaped inner wall of the coiling spring cartridge 92 facing the brake pawl 32. It should be noted that the specific count of the third internal teeth 922 may be set according to the actual needs.

When the long webbing 3 is normally unwound, the reeling shaft 7 and the limiting disk 34 fixed at the end of the reeling shaft 7 drive the brake pawl 32 to rotate, and when the unwinding speed is slow, the brake pawl 32 will not be thrown away due to the elastic force of the return spring 33, and when the unwinding speed is too fast, the centrifugal force generated exceeds the elastic force of the return spring 33, and the brake pawl 32 will be thrown away, but according to the principle of the ratchet wheels, at this time, the third outer contour tooth 321 of the brake pawl 32 come into contact with the third internal teeth 922 of the coiling spring cartridge 92, but they do not engage, allowing the long webbing 3 to be continuously unwound (as shown in FIG. 27). When the long webbing 3 is wound up, the reeling shaft 7 and the limiting disk 34 fixed at the end of the reeling shaft 7 drive the brake pawl 32 to rotate in the other direction, so that when the winding speed is slow, the centrifugal force generated does not exceed the elastic force of the return spring 33, the brake pawl 32 will not be thrown away, the third outer contour tooth 321 of the brake pawl 32 does not come into contact with the third internal teeth 922 of the coiling spring cartridge 92, and the long webbing 3 may be continuously wound up (as shown in FIG. 29A-FIG. 29B) When the rewinding speed is too fast, the centrifugal force generated exceeds the elastic force of the return spring 33, the brake pawl 32 is thrown away, the third outer contour tooth 321 of the brake pawl 32 engages with the third internal teeth 922 on the coiling spring cartridge 92, the brake assembly 10 is in a braking state, the reeling shaft 7 cannot be rotated, and the rewinding of the long webbing 3 is locked (as shown in FIG. 28). After locking, only a short section of the long webbing 3 needs to be pulled out, the brake pawl 32 is reset under the action of the elastic force of the return spring 33, and the third outer contour tooth 321 of the brake pawl 32 is disengaged from the third internal teeth 922 on the coiling spring cartridge 92, and the long webbing 3 may be wound up.

It should be understood that the brake pawl 32 and the third outer contour teeth 321 disposed on the outer periphery of the brake pawl 32 may be designed in a variety of structural shapes, and the specific count of the third outer contour teeth 321 may be set according to actual needs, as shown in FIG. 29A-FIG. 29B. At the same time, the brake pawl 32 and the limiting disk 34 may be connected in a variety of ways, which are not limited in the present disclosure.

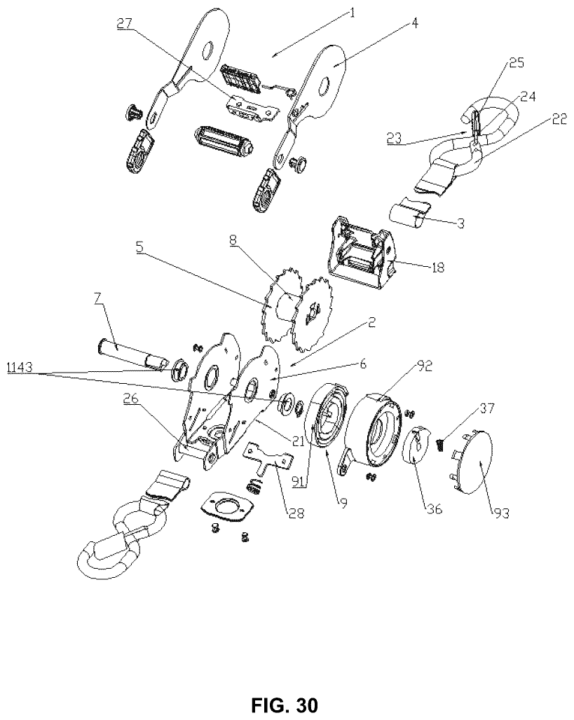

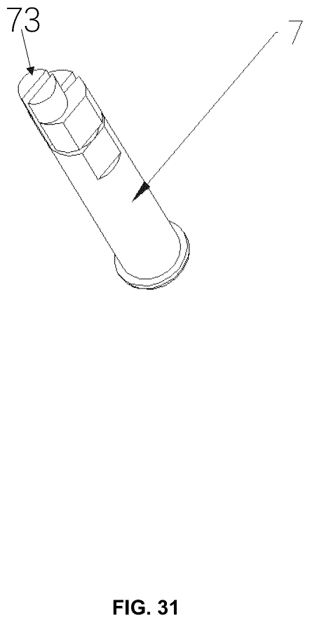

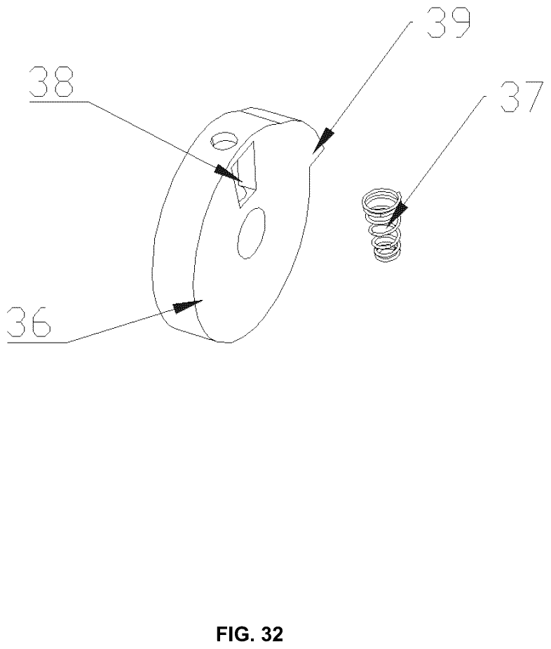

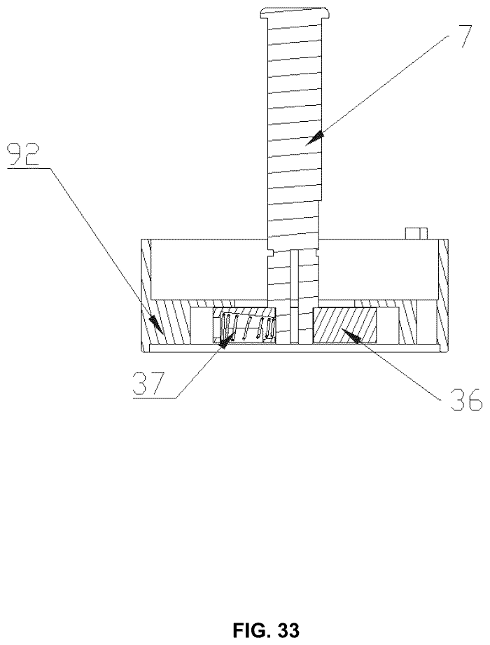

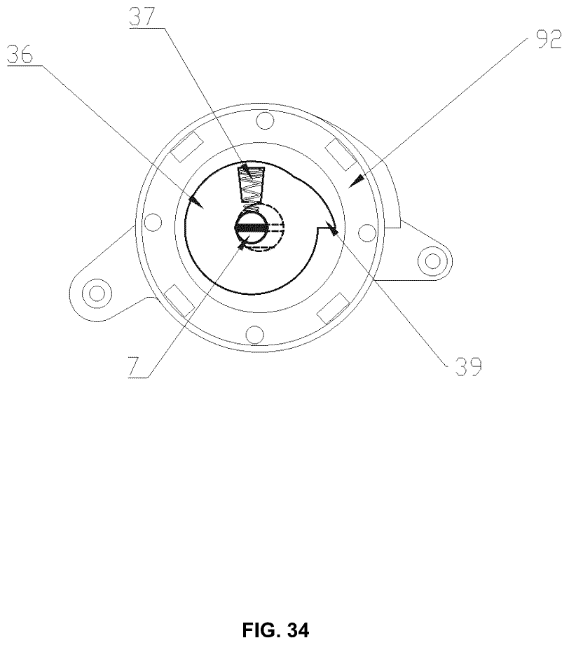

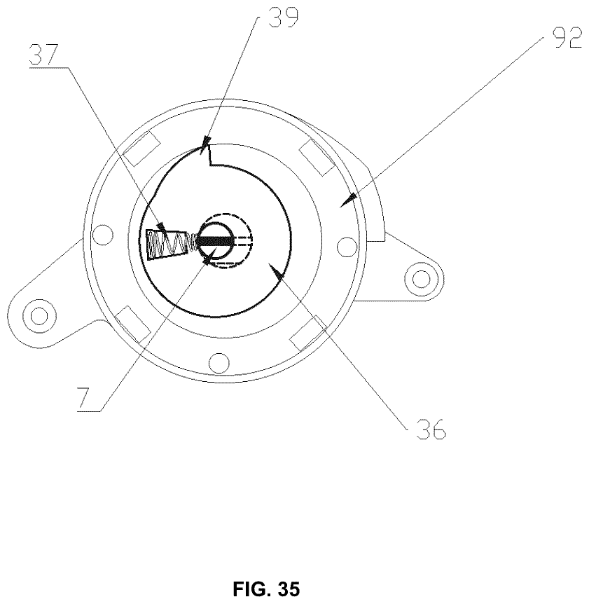

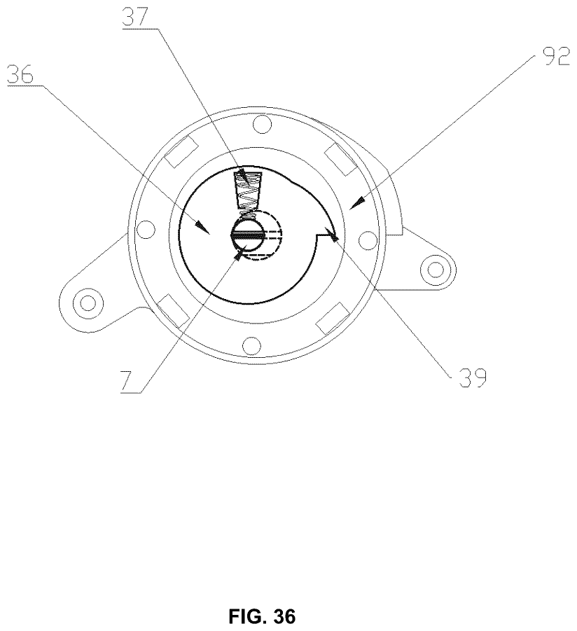

FIG. 30 is an exploded schematic diagram of an exemplary tensioning device according to some other embodiments of the present disclosure. FIG. 31 is a schematic diagram of a structure of an exemplary reeling shaft according to some other embodiments of the present disclosure. FIG. 32 is a schematic diagram of a structure of an exemplary brake assembly according to some other embodiments of the present disclosure. FIG. 33 is a schematic diagram of a structure of an exemplary brake assembly according to some other embodiments of the present disclosure. FIG. 34 is an internal schematic diagram of an exemplary brake assembly (in an unwinding state) according to some other embodiments of the present disclosure. FIG. 35 is an internal schematic diagram of an exemplary brake assembly (in a locked state) according to some other embodiments of the present disclosure. FIG. 36 is an internal schematic diagram of an exemplary brake assembly (in a winding state) according to some other embodiments of the present disclosure.

Some embodiments of the present disclosure also provide a tensioning device. As shown in FIG. 30-FIG. 36, the difference from the foregoing tensioning device is that, in this tensioning device, a second eccentric shaft 73 is disposed on one end of the reeling shaft 7, and the brake assembly 10 includes a brake disk 36 and a compression spring 37, the brake disk 36 is provided with a recess 38, an outer contour flange 39 is disposed on an outer periphery of the brake disk 36 that is close to the coiling spring cartridge 92, the brake disk 36 is connected to the second eccentric shaft 73 of the reeling shaft 7, the compression spring 37 is mounted in the recess 38, one end of the compression spring 37 abuts against the brake disk 36, the other end of the compression spring 37 abuts against the second eccentric shaft 73 of the reeling shaft 7, and the brake disk 36 rotates synchronously with the reeling shaft 7.

When the long webbing 3 is normally unwound, the reeling shaft 7 and the second eccentric shaft 73 at the end of the reeling shaft 7 drive the brake disk 36 to rotate, and the long webbing 3 may be continuously unwound (as shown in FIG. 34). When the long webbing 3 is wound up, the reeling shaft 7 and the second eccentric shaft 73 at the end of the reeling shaft 7 drive the brake disk 36 to rotate in the other direction, so that when the winding speed is slow, the centrifugal force generated does not exceed the elastic force of the compression spring 37, the brake disk 36 will not be thrown away, the outer contour flange 39 of the brake disk 36 does not contact the inner wall of the coiling spring cartridge 92, and the long webbing 3 may be wound up continuously (as shown in FIG. 36). When the winding speed is too fast, the centrifugal force generated exceeds the elastic force of the compression spring 37, the brake disk 36 is thrown away, the outer contour flange 39 of the brake disk 36 engages with the inner wall on the coiling spring cartridge 92, and the brake assembly 10 is in a braking state, the reeling shaft 7 cannot be rotated, and the rewinding of the long webbing 3 is locked (as shown in FIG. 35). After locking, only a short section of the long webbing 3 needs to be pulled out, the brake disk 36 is reset by the elastic force of the compression spring 37, and the outer contour flange 39 of the brake disk 36 is disengaged from the inner wall on the coiling spring cartridge 92, and the long webbing 3 may be wound up.

The basic concepts have been described above. Obviously, for those skilled in the art after reading the present disclosure, the above disclosure may be only an example and may not constitute a limitation to the present disclosure. Although not explicitly described herein, various modifications, improvements, and corrections to the present disclosure may be performed by those skilled in the art. Such modifications, improvements, and corrections may be suggested in the present disclosure, so such modifications, improvements, and corrections may still belong to the spirit and scope of the exemplary embodiments of the present disclosure.

What is claimed is:

1. A tensioning device for controlling a webbing, comprising a handle assembly, a base assembly, and a long webbing, wherein the handle assembly includes a handle and ratchet wheels, the base assembly includes a base, the handle and the base are pivotally connected with each other through a reeling shaft, the ratchet wheels are fixedly mounted on the reeling shaft, a reel is fixed between the ratchet wheels, the ratchet wheels, the reel, and the reeling shaft rotate synchronously, the reel is sleeved outside the reeling shaft and disposed coaxially, one side of the reel is provided with an opening for the long webbing to pass through, one end of the long webbing is sleeved on the reeling shaft, and the other end of the long webbing is led out from one end of the base through the opening on the reel, one end of the reeling shaft is connected to a coiling spring assembly, the coiling spring assembly includes a coiling spring and a coiling spring cartridge sleeved on the coiling spring, the base includes a base side plate and a base bottom plate, and an upper side curved surface of the base side plate is divided into a release zone and a tensioning working zone in turn.

2. The tensioning device according to claim 1, wherein the coiling spring assembly further includes a coiling cartridge cover, the coiling cartridge cover is disposed on the coiling spring cartridge, and a brake assembly is disposed in the coiling spring cartridge.

3. The tensioning device according to claim 1, wherein the upper side curved surface of the base side plate is provided with a first protrusion, the first protrusion dividing the upper side curved surface of the base side plate into the release zone and the tensioning working zone.

4. The tensioning device according to claim 3, wherein the base side plate and the base bottom plate are of one-piece construction, the base side plate being perpendicular to the base bottom plate and symmetrically disposed on both sides of the base bottom plate.

5. The tensioning device according to claim 4, wherein a first pawl sliding groove is disposed at a rear side of the base side plate, a first limiting plate is disposed at a rear side of the base bottom plate, the first pawl sliding groove is provided with a first pawl, the first pawl is T-shaped, both ends of the first pawl are slidably disposed at the first pawl sliding groove, a first reset spring is sleeved on a lower end of the first pawl, which is inserted into the first limiting plate and slidably matched with the first limiting plate; and the first pawl elastically slides in a direction of the first pawl sliding groove under an action of the first reset spring, and the first pawl is correspondingly cooperated with the ratchet wheels.

6. The tensioning device according to claim 1, wherein the handle includes a handgrip and handle side plates, the handle side plates are connected to the handgrip and symmetrically disposed on both sides of the handgrip, the handle side plates are coaxially rotationally connected to the base side plate through a sleeve, the sleeve is connected with the reeling shaft so that the handle side plates are freely rotatable with the reeling shaft as a central axis, the handle side plates are provided with symmetrical second pawl slide grooves, the second pawl slide grooves are provided with a second pawl, the second pawl is L-shaped, a plastic sleeve is disposed at an upper end of the second pawl, and two ends of the second pawl are slidably disposed at the second pawl slide grooves, the second pawl is connected to one side of one of the handle side plates by a torsion spring; and the second pawl elastically slides in a direction of each of the second pawl slide grooves under an action of the torsion spring, and the second pawl is correspondingly cooperated with the ratchet wheels.

7. The tensioning device according to claim 6, wherein the two ends of the second pawl extend out of the second pawl slide grooves and fit in the upper side curved surface of the base side plate under the action of the torsion spring.

8. The tensioning device according to claim 6, wherein a first squeezing surface and a second squeezing surface for squeezing a first pawl are disposed on a lower side curved surface of the handle side plate.

9. The tensioning device according to claim 3, wherein the upper side curved surface of the base side plate is further divided into an unloading section, a tightening section, and a releasing section in turn, a first locking port being disposed between the unloading section and the tightening section, and a second locking port being disposed at an end of the releasing section.

10. The tensioning device according to claim 2, wherein one end of the reeling shaft is provided with a C-shaped opening, and the brake assembly includes a limit tooth and a pendulum tooth, the limit tooth is connected to the coiling spring cartridge, a plurality of first internal teeth are disposed on a ring-shaped inner wall of the limit tooth that is close to the reeling shaft, a hole is in a center of the pendulum tooth, a linkage groove and a brake groove are disposed in the hole, a diagonal over-section is disposed between the linkage groove and the brake groove, the pendulum tooth is eccentrically sleeved on the C-shaped opening at the end of the reeling shaft, a first outer contour tooth is disposed on an outer side of the pendulum tooth away from the brake groove, and the pendulum tooth rotates synchronously with the reeling shaft.

11. The tensioning device according to claim 2, wherein a first eccentric shaft is disposed at one end of the reeling shaft, and the brake assembly includes a locking pawl, a spring, and a fixing member, the fixing member is connected to the reeling shaft, the fixing member rotates synchronously with the reeling shaft, a second outer contour tooth is disposed on an outer periphery of the locking pawl close to the coiling spring cartridge, the locking pawl is connected to the first eccentric shaft at the end of the reeling shaft, the spring is disposed between the locking pawl and the fixing member, one end of the spring is connected to the fixing member, and the other end of the spring is connected to the locking pawl to provide a force for the locking pawl to close toward the reeling shaft; and
a plurality of second internal teeth, which are consecutive and circumferentially arranged, are disposed on a ring-shaped inner wall of the coiling spring cartridge facing the locking pawl.

12. The tensioning device according to claim 3, wherein an end of the reeling shaft is provided with a concentric screw hole, and the brake assembly includes a brake pawl, a return spring, a limiting disk, and a screw, the limiting disk is fixed at the end of the reeling shaft by matching the screw with the concentric screw hole, the limiting disk rotates synchronously with the reeling shaft, a third outer contour tooth is disposed on an outer periphery of the brake pawl close to the coiling spring cartridge, the brake pawl is connected to the limiting disk, the return spring is disposed between the brake pawl and the limiting disk, one end of the return spring is connected to the limiting disk, and the other end of the return spring is connected to the brake pawl to provide a force for the brake pawl to close toward the reeling shaft; and
a plurality of third internal teeth, which are consecutive and circumferentially arranged, are disposed on a ring-shaped inner wall of the coiling spring cartridge facing the brake pawl.

13. The tensioning device according to claim 3, wherein a second eccentric shaft is disposed on one end of the reeling shaft, and the brake assembly includes a brake disk and a compression spring, the brake disk is provided with a recess, an outer contour flange is disposed on an outer periphery of the brake disk that is close to the coiling spring cartridge, the brake disk is connected to the second eccentric shaft of the reeling shaft, the compression spring is mounted in the recess, one end of the compression spring abuts against the brake disk, the other end of the compression spring abuts against the second eccentric shaft of the reeling shaft, and the brake disk rotates synchronously with the reeling shaft.

14. The tensioning device according to claim 1, wherein a front cover is disposed on one end of the base close to the long webbing, the front cover is provided with a webbing channel for the long webbing to pass through and provided with symmetrical limit walls, and a bottom of the base is provided with symmetrical limit ports that are strip-shaped, the limit walls and the limit ports cooperating for limiting the handle and avoiding interference between sides of the handle and the ratchet wheels.

15. The tensioning device according to claim 14, wherein the long webbing is connected with a hook, the front cover is disposed at one end of the base, the webbing channel on the front cover extends toward the other end of the base, and the webbing channel is in a constricted shape and is configured to catch one end of the hook.

16. The tensioning device according to claim 15, wherein a safety mechanism is disposed at an opening of the hook, the safety mechanism includes a return-action spring and a safety sleeve, the return-action spring is mounted on the hook, the safety sleeve is disposed on the return-action spring and elastically closes the opening of the hook under an action of the return-action spring.

17. The tensioning device according to claim 16, wherein a detachable connecting shaft is disposed on an end of the base opposite to the long webbing, and the detachable connecting shaft is connected with at least one of a short webbing, a hooklet, a snap, or a fixed plate.
